(19) United States
(12) Patent Application Publication
(10) Pub. No.: US 2026/0195600 A1
(43) Pub. Date: Jul. 9, 2026

(54) Methods and Systems for Collaborative Orchestration by Agents

(71) Applicant: Wolters Kluwer Global Business Services B.V., Alphen aan den Rijn (NL)

(72) Inventors: Sam Kardan, Ramsey, NJ (US); Prashanth Kashyap, New Rochelle, NY (US); Sumanth Muralidhar, Houston, TX (US); Jeremy Coles, Fishers, IN (US)

(21) Appl. No.: 19/204,316

(22) Filed: May 9, 2025

Related U.S. Application Data
(60) Provisional application No. 63/742,320, filed on Jan. 6, 2025.

(51) Int. Cl. G06N 3/0895

(52) U.S. Cl. CPC G06N 3/0895

(57) ABSTRACT

A computer system receives, by an interface agent and via a web user interface, a first user query from a user that defines a request to summarize historical data corresponding to a critical event associated with a plurality of computing incidents. In response to receiving the first user query, the computer system instantiates, by an executing agent, an event report associated with the critical event. The computer system displays the event report to the user. The computer system receives, by the interface agent and via the web user interface, a second user query from the user that defines a request to reduce a mean time to repair (MTTR) for resolving the critical event. In response to receiving the second user query, the computer system instantiates, by the executing agent, an enhanced standard operating procedure (SOP) configured to reduce the MTTR. The computer system displays the enhanced SOP to the user.

### RELATED AND PRIORITY APPLICATIONS

This application claims priority to U.S. Provisional App. No. 63/742,320, filed on Jan. 6, 2025, which is hereby incorporated by reference in its entirety.

### TECHNICAL FIELD

The disclosed embodiments relate generally to artificial intelligence platforms, and, in particular, to managing agents for processing tasks.

### BACKGROUND

Information technology (IT) systems (e.g., within cloud platforms) are rapidly growing in complexity and scale (e.g., due to relentless cybersecurity threats, exponentially increased customer demands for new features, etc.). This growth brings increased challenges while simultaneously enhancing system power and flexibility.

Existing IT systems encounter several concerns. A first concern is related to operational inefficiencies. Specifically, the exponential growth and complexity of cloud systems result in increased management challenges and rising costs, prolonged mean time to repair (MTTR) for resolving issues, and extensive time for root cause analysis (RCA), collectively impacting service quality. A second concern is related to the limitations of human-only teams. Specifically, the rapid pace of changes in existing IT systems surpasses human capabilities, leading to reduced productivity, skill and speed constraints, increased human errors, elevated stress levels and burnout, and an inability to meet growing demands. A third concern is related to the imperative for innovation.

### SUMMARY

The explosive growth of cloud technology makes IT systems more complex yet immensely powerful and flexible. For example, cloud environments of a service entity (e.g., a company for information service, technology service, network service, and/or other types of services) may experience exponential growth to support increasing service demands. Various of embodiments are directed to methods and systems for providing an agentic orchestration platform based on an agentic system that allows agents to dynamically, autonomously, and adaptively solve tasks (e.g., critical and high-priority incidents) associated with service demands. In particular, the agentic system accelerates operational efficiencies, e.g., delegating complex tasks to autonomous artificial intelligence (AI) agents under supervision, increasing productivity across various business and IT processes, decreasing mean time to repair (MTTR), and decreasing time to perform RCA root cause analysis (RCA). Moreover, the agentic system unlocks human potential through AI, e.g., exponentially enhancing productivity across various functions (e.g., ITs, finance, businesses, etc.), accelerating process by augmenting human teams with using AI agents, delighting consumers and customers by creating a stress-free experience, and boosting the capability meet and exceed growing demands. Additionally, the agentic system revolutionizes cloud technologies and markets for IT systems, e.g., bring AI augmentation across various business units, infrastructure, and applications, achieving streamlined operations that drives cost reduction and enhances efficiencies for both internal operations and customers, and leveraging AI and automation for optimizing IT resources.

In accordance with some embodiments, a method is provided. A method of orchestrating agents for a user task includes generating, based on a user request and by a first agent, a workflow. The workflow includes a plurality of steps. The method further includes generating, based on the workflow and by a second agent, one or more on-demand agents. Each of the plurality of steps is assigned to a respective on-demand agent of the one or more on-demand agents. The method further includes analyzing the workflow by the one or more on-demand agents to generate output data. The method further includes receiving user supervision associated with the output data by the first agent. The method further includes determining, based on the user supervision and by the second agent, whether the output data requires updating. The method further includes in accordance with a determination that the output data requires updating, updating the output data. The method further includes displaying the updated output data to a user. Each agent of the first agent, the second agent, and the one or more on-demand agents is driven by a respective computational component from a plurality of computational components.

In accordance with some embodiments, a method is provided. A method of orchestrating artificial intelligence agents for a user task includes instantiating, based on a request from a user and by an external interface artificial intelligence agent, a workflow. The workflow includes a plurality of steps configured to resolve a critical computing event. The method further includes instantiating, based on the workflow and by an internal orchestrating artificial intelligence agent, one or more on-demand artificial intelligence agents. The method further includes executing the workflow by the one or more on-demand artificial intelligence agents to generate output data for the internal orchestrating artificial intelligence agent. Executing the workflow includes, for each of the plurality of steps: assigning a respective step to a respective on-demand artificial intelligence agent of the one or more on-demand artificial intelligence agents; and executing, by the respective on-demand artificial intelligence agent, the respective step to generate respective data. The method further includes transmitting, by the internal orchestrating artificial intelligence agent, the output data to the external interface artificial intelligence agent. The method further includes displaying, by the external interface artificial intelligence agent, the output data to the user. The method further includes receiving user supervision corresponding to the critical computing event and the output data. The method further includes transmitting, by the external interface artificial intelligence agent, the user supervision to the internal orchestrating artificial intelligence agent. The method further includes determining, based on the user supervision and by the internal orchestrating artificial intelligence agent, whether the output data requires updating. The method further includes in accordance with a determination that the output data requires updating, updating, by the one or more on-demand artificial intelligence agents, the output data to generate updated output data for the internal orchestrating artificial intelligence agent. The method further includes transmitting, by the internal orchestrating artificial intelligence agent, the updated output data to the external interface artificial intelligence agent. The method further includes displaying, by the external interface artificial intelligence agent, the updated output data to the user. Each artificial intelligence agent of the external interface artificial intelligence agent, the internal orchestrating artificial intelligence agent, and the one or more on-demand artificial intelligence agents is distinct from every other artificial intelligence agent and includes a large-language model.

In accordance with some embodiments, a method is provided. A method of orchestrating agents for resolving incidents includes receiving, from a user, an incident defining a target issue to be addressed. The method further includes convening in real-time, based on the incident and by a coordinating agent, a call that defines a collaboration. The method further includes dynamically spawning, using computational resources, one or more on-call agents corresponding to the collaboration. The method further includes generating, by the one or more on-call agents, output data. The method further includes transmitting the output data to the user. The method further includes automatically terminating the one or more on-call agents by releasing the computational resources.

In accordance with some embodiments, a method is provided. A method of orchestrating artificial intelligence agents for resolving incidents includes receiving, from a user, a critical computing incident defining a target issue to be addressed. The method further includes instantiating in real-time, based on the critical computing incident and by an interface coordinating artificial intelligence agent, a call that defines a collaboration. The method further includes dynamically allocating a set of computational resources from a pool of computational resources to the collaboration. The method further includes dynamically spawning, using the set of computational resources, one or more on-call artificial intelligence agents corresponding to the collaboration. The method further includes generating, by the one or more on-call artificial intelligence agents, output data. The method further includes transmitting the output data to the user. The method further includes automatically monitoring a usage status of the pool of computational resources. The method further includes automatically terminating, based on the usage status, the one or more on-call artificial intelligence agents by releasing the set of computational resources. Each artificial intelligence agent of the interface coordinating artificial intelligence agent and the one or more on-call artificial intelligence agents is distinct from every other artificial intelligence agent and includes a large-language model.

In accordance with some embodiments, a method is provided. A method of orchestrating agents for resolving incidents includes receiving, by an interface agent and via a web user interface, a first user query from a user that defines a request to summarize historical data corresponding to a critical event associated with a plurality of incidents. The method further includes in response to receiving the first user query, generating, by an executing agent, an event report associated with the critical event. The method further includes displaying, by the interface agent and via the web user interface, the event report to the user. The method further includes receiving, by the interface agent and via the web user interface, a second user query from the user that defines a request to reduce a mean time to repair (MTTR) for resolving the critical event. The method further includes in response to receiving the second user query, generating, by the executing agent, an enhanced standard operating procedure (SOP) configured to reduce the MTTR for resolving the critical event. The method further includes displaying, by the interface agent and via the web user interface, the enhanced SOP to the user.

In accordance with some embodiments, a method is provided. A method of orchestrating artificial intelligence agents for self-service includes receiving, by an interface artificial intelligence agent and via a web user interface, a first user query from a user that defines a request to summarize historical data corresponding to a critical computing event associated with a plurality of computing incidents. The method further includes in response to receiving the first user query, generating, by an executing artificial intelligence agent, an event report associated with the critical computing event. The method further includes displaying, by the interface artificial intelligence agent and via the web user interface, the event report to the user. The method further includes in response to receiving the second user query, generating, by the executing artificial intelligence agent, an enhanced standard operating procedure (SOP) configured to reduce the MTTR for resolving the critical computing event. The method further includes displaying, by the interface artificial intelligence agent and via the web user interface, the enhanced SOP to the user. Each artificial intelligence agent of the interface coordinating artificial intelligence agent and the one or more on-call artificial intelligence agents is distinct from every other artificial intelligence agent and includes a large-language model.

In accordance with some embodiments, a computer system is provided. The computer system includes one or more processors and memory storing one or more programs. The one or more programs are configured to be executed by the one or more processors. The one or more programs include instructions for performing any of the methods described herein.

In accordance with some embodiments, a non-transitory computer-readable storage medium is provided. The one or more programs comprises instructions that, when executed by a computer system that includes one or more processors, cause the one or more processors to perform operations for any of the methods described herein.

These illustrative aspects are mentioned not to limit or define the disclosure, but to provide examples to aid understanding thereof. Additional embodiments are discussed in the Detailed Description, and further description is provided there.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating an agentic orchestration platform including an agentic system, in accordance with some embodiments.

FIG. 2 is a block diagram illustrating a computer system that supports the agentic system, in accordance with some embodiments.

FIG. 3 illustrates an example agentic orchestration platform, in accordance with some embodiments.

FIG. 4 illustrates an example user interface built for the agentic system, in accordance with some embodiments.

FIG. 5A illustrates an example incident management framework that does not implement the agentic system, and FIG. 5B illustrates another example incident management framework that implements the agentic system, in accordance with some embodiments.

FIG. 6 illustrates an example incident management framework that implements the agentic system, in accordance with some embodiments.

FIG. 7 illustrates an example self-service framework that implements the agentic system, in accordance with some embodiments.

FIGS. 8A-8E illustrate an example webUI of the agentic system, in accordance with some embodiments.

FIG. 9 is a flow diagram illustrating a method of orchestrating agents for a user task, in accordance with some embodiments.

FIG. 10 is a flow diagram illustrating a method of orchestrating agents for resolving incidents, in accordance with some embodiments.

FIG. 11 is a flow diagram illustrating a method of orchestrating agents for self-service, in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first widget could be termed a second widget, and, similarly, a second widget could be termed a first widget, without departing from the scope of the various described embodiments. The first widget and the second widget are both widgets, but they are not the same widget.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The explosive growth of cloud technology makes IT systems more complex yet immensely powerful and flexible. For example, cloud environments of a service entity (e.g., a company for information service, technology service, network service, and/or other types of services) may experience exponential growth to support increasing service demands. In some circumstances, the exponential growth of the cloud environments is manifested as the utilization of hundreds or thousands of cloud accounts across various cloud computing platforms to deliver services to customers, with a growth rate of approximately 20-30% annually or 2-3% monthly. In particular, IT systems continue to encounter a significant volume of critical and high-priority incidents (e.g., hundreds or thousands of incidents annual). Accordingly, resolving these incidents is intensive, requiring an estimated 20-50 days to address every 100 critical and high-priority incidents.

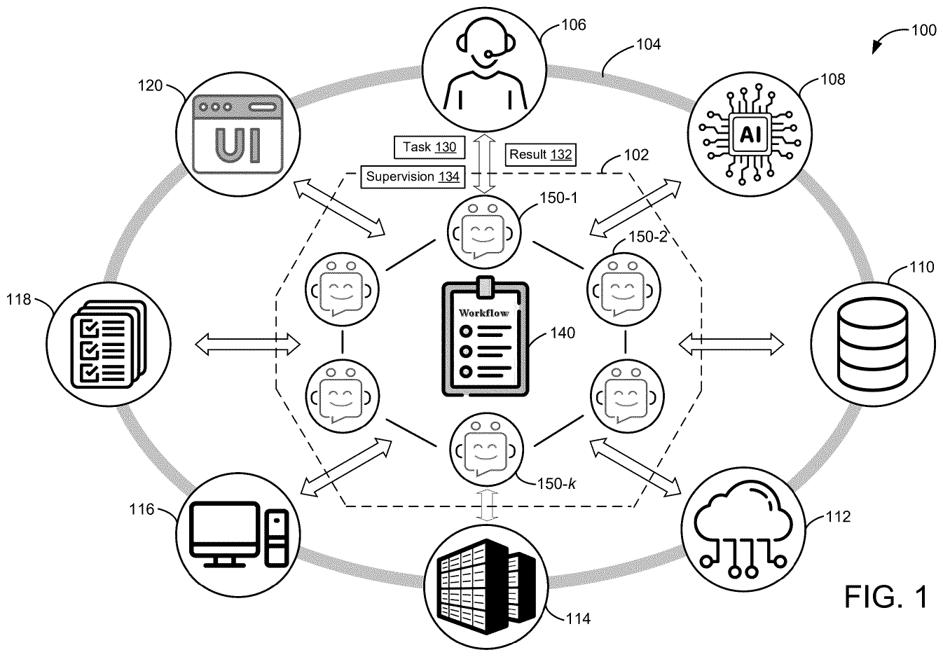

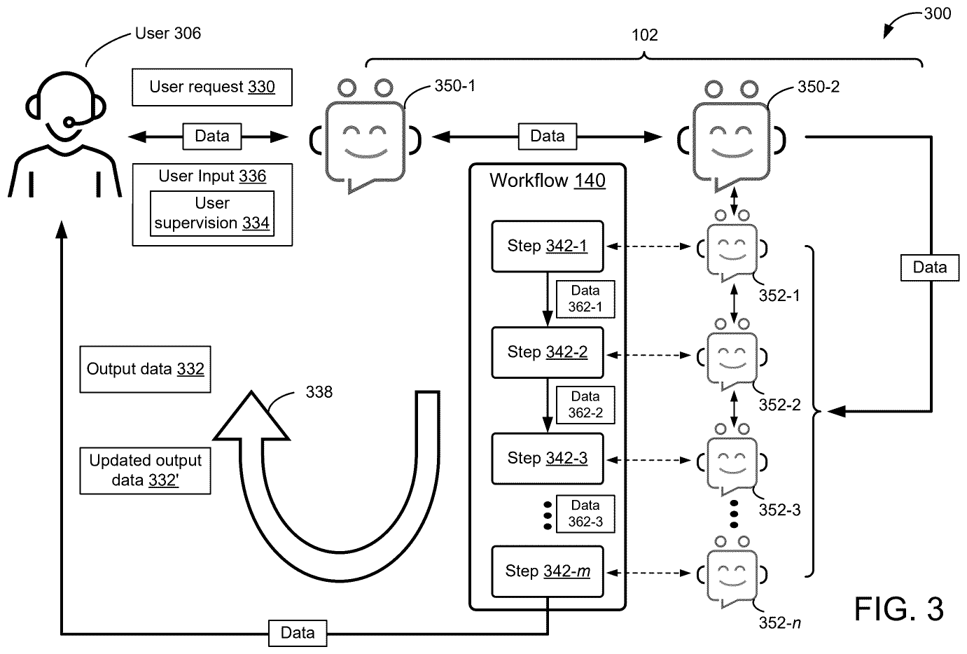

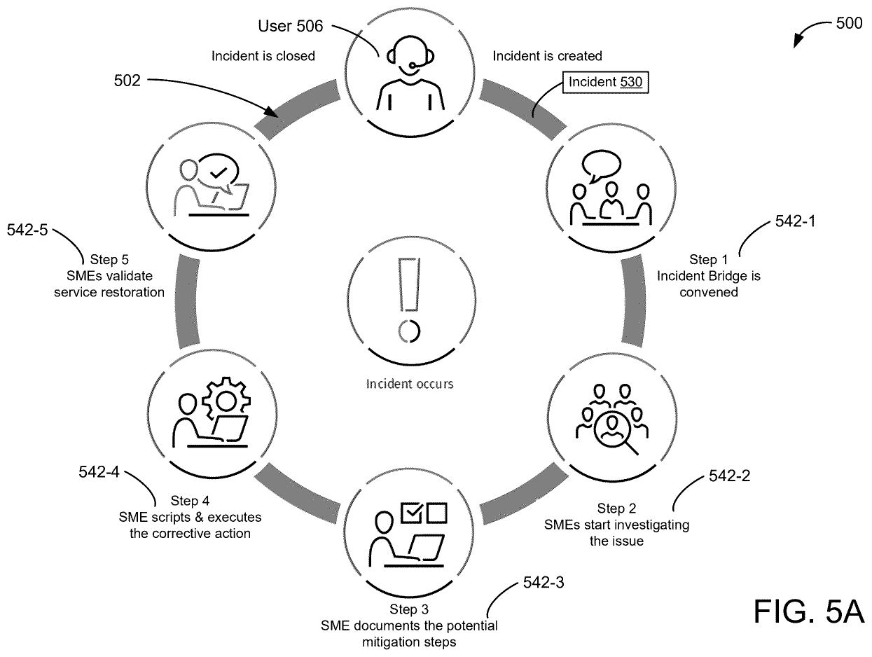

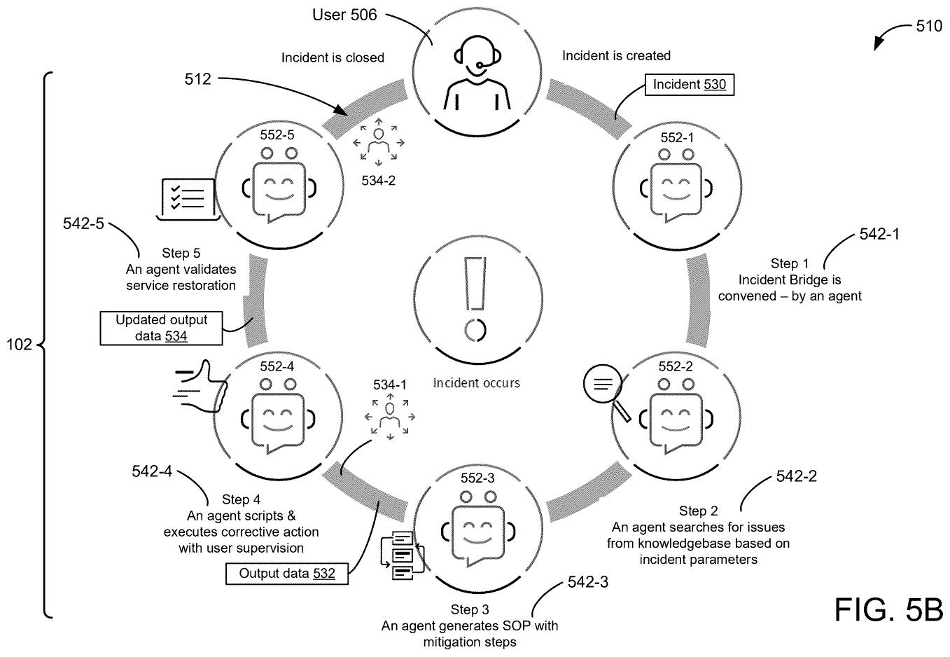

Various of embodiments presented in this application are directed to methods and systems for providing an agentic orchestration platform (e.g., agentic orchestration platform 100 in FIG. 1) based on an agentic system (e.g., agentic system 102 in FIG. 1) that allows agents to dynamically, autonomously, and adaptively solve tasks (e.g., resolving critical and high-priority incidents). In some embodiments, the agents (e.g., agent 150 in FIG. 1, agent 350 and agent 352 in FIG. 3, agent 552 in FIG. 5B) of the agentic system are AI agents driven by computational components (e.g., analytical models, machine-learning models, large-language models (LLMs), plugins, other types of models, or a combination of various types). In some embodiments, the agentic system operates under supervision (e.g., user supervision, user input, user interception, etc.) and is configured to provide ethical decision-making and adaptability in complex, dynamic environments.

Various of embodiments presented in this application may offer the advantages including, but not limited to, enhancing operational efficiency, surpassing human limitations with AI augmentation, and providing hardware improvements for IT system infrastructure.

First, the agentic system (e.g., agentic system 102 in FIG. 1) enhances operational efficiency by assisting application & business owners, IT development, security & operations, and incident & problem management, with respect to (i) automated solutions for repetitive and time-consuming tasks, (ii) quick, concise, and actionable insights, (iii) minimal need for constant manual intervention, (iv) enhanced system reliability and performance, and (v) retaining human oversight for critical decisions. In particular, the agentic system resolves significant challenges including (i) reduced organizational efficiency due to the inability to remediate at scale and (ii) increased downtime during incidents which have financial, regulatory, and legal consequences. Moreover, the agentic system addresses several issues including (i) slow-down of manual processes, (ii) high operational costs due to excessive manpower, (iii) increased workload from handling repetitive tasks that lead to potential burnout for humans, and (iv) delays in incident resolution leading to severe financial and regulatory risks. For example, a critical and high-priority incident may require an IT system to run vulnerability detection scripts on over tens of thousands (e.g., 10,000 to 50,000) of computer servers globally, incurring a significant financial and manpower cost. In another example, an unplanned application outage would make an IT service company encounter a few hours of unplanned downtime per week, leading to significant impacts on IT systems (e.g., system operations) and customer experiences (e.g., user satisfaction). In this situation, the agentic system can be implemented to automate and optimize error detection, at-scale remediation, and incident management, which are crucial to improve operational efficiency and reduce downtime and cost (e.g., on manpower, finance, etc.).

Second, the agentic system (e.g., agentic system 102 in FIG. 1) surpasses human limitations by leveraging AI to augment and execute tasks (e.g., for operations in IT systems). For example, in some embodiments, the agentic system implements agents (e.g., AI agents) that are driven by computational components (e.g., data analytics, analytical models, machine-learning models, LLMs, plugins, other types of models, or a combination of various types) and configured as an integrated multi-agent framework. In particular, the integrated multi-agent framework is configured to reason, learn, execute tasks, and make decisions while communicating and collaborating internally (e.g., between agents) and externally (e.g., with humans/users) to solve tasks (e.g., critical and high-priority incidents, user requests, user queries). Specifically, in some embodiments, the agentic system receives supervision (e.g., user supervision, user input, user interception) to make more effective decisions and ensure safety and accuracy. Additionally, the AI augmentation also enhances the agentic system's capabilities with respect to (i) automating IT operations by eliminating inefficiencies and excessive costs (e.g., manpower), (ii) offering versatility and adaptation across various applications (e.g., Software as a Service (SaaS), IT operations, back-office systems, etc.) processes (e.g., decision-makings, optimizations, etc.), and (iii) boosting productivity by freeing human teams from repetitive tasks.

Third, the agentic system (e.g., agentic system 102 in FIG. 1) provides hardware improvements for IT system infrastructure. For example, the agentic system can optimize hardware utilization, e.g., monitoring hardware performance in real-time and ensuring optimal usage by dynamically allocating resources (e.g., resource of functional platforms 104 in FIG. 1) based on real-time demands of tasks (e.g., critical and high-priority incidents). In another example, the agentic system can optimize hardware configurations for IT system infrastructure, e.g., tuning hardware components (e.g., allocation of databases, memory, computing devices) of an IT system for peak performance, adjusting workloads and identifying inefficiencies within hardware components that slow operations, and extending lifespan hardware components by evenly distributing workloads. In yet another example, the agentic system can perform legacy leapfrogging (e.g., bypassing outdated infrastructure for immediate advancements). In yet another example, the agentic system optimizes the utilization of system resources (e.g., resources in the plurality of functional platforms 104) by dynamically monitoring workloads and efficiently releasing resources that are no longer needed (e.g., releasing an agent that was earlier created but is no longer needed).

FIG. 1 is a block diagram illustrating an agentic orchestration platform 100 including an agentic system 102, in accordance with some embodiments. The agentic orchestration platform 100 includes the agentic system 102 and a plurality of functional platforms 104. The agentic system 102 is configured to bidirectionally communicate with the plurality of functional platforms 104 for receiving data (e.g., tasks, requests, inputs), sending data (e.g., results, documentations), managing resources (e.g., storages, computing resources, training powers, etc.), and integrating functionalities (e.g., coordinating multiple resources between the plurality of functional platforms 104).

In some embodiments, the plurality of functional platforms 104 of the agentic orchestration platform 100 include, but are not limited to a user platform 106 (e.g., service centers, user/task management systems, content delivery networks, etc.), an AI platform 108 (e.g., machine learning operations, model training frameworks, natural language processing, etc.), a database platform 110 (e.g., data storage devices, database management systems, relational databases, data warehouses, data lakes, etc.), a cloud platform 112 (Infrastructure as a Service, Platform as a Service, serverless computing resources, etc.), a computing platform 114 (e.g., operating systems, virtual machines, containerization platforms, etc.), a device platform 116 (e.g., device terminals, workstations, applications, mobile operation systems, embedded systems, internet-of-thing platforms, etc.), a documentation platform 118 (e.g., documentation controls, editors, documentation related software, etc.), and a user interface (UI) platform 120 (e.g., web applications, UI component libraries, cross-platform UI toolkits, etc.).

In some embodiments, the agentic system 102 of the agentic orchestration platform 100 includes a plurality of agents 150 (e.g., agent 150-1 to agent 150-k, where k is an integer greater than two). In some embodiments, the plurality of agents 150 receive a task 130 (e.g., a user request, a user query, a critical and high-priority incident) from a user (e.g., a user/human of the user platform 106), generate a workflow 140 based on the task 130, analyze the workflow 140 to obtain a result 132, and send the result 132 to the user. In particular, when processing the task 130, the plurality of agents 150 utilize various resources provided by the plurality of functional platforms 104. For example, a respective agent (e.g., agent 150-1) communicates with the AI platform 108 to access machine learning models, LLMs, and/or computing powers for neural networks. In another example, the plurality of agents 150 receive data from (e.g., historical incidents, standard of procedures (SOPs)) and store data (e.g., new incidents, updated SOPs) to the database platform 110. In yet another example, one or more agents of the plurality of agents 150 are dynamically created (e.g., on an as-needed basis, on-demand) using resources provided in the plurality of functional platforms 104. In some embodiments, a respective agent (e.g., agent 150-1) of the plurality of agents 150 is a central agent and remaining agents (e.g., agents 150-2 to 150-k) of the plurality of agents 150 are non-central agents. For example, the central agent (e.g., agent 150-1) is configured to communicate externally with the user (e.g., via the user platform 106) to receive the task 130, generate the workflow 140 based on the task 130, coordinate (e.g., orchestrate) the non-central agents to analyze the task 130 to generate the result 132, and send the result 132 to the user. In another example, the central agent (e.g., agent 150-1) dynamically creates one or more agents of the plurality of agents 150 using a combination of resources provided in the plurality of functional platforms 104 (e.g., creating a respective agent 150-2 on demand using resources provided by the AI platform 108, the cloud platform 112, and the computing platform 114).

In some embodiments, the agentic system 102 is configured to dynamically create (e.g., on an as-needed basis, on-demand) one or more agents of the plurality of agents 150 to augment human capabilities (e.g., for resolving critical and high-priority incidents, handling complex, time-consuming tasks), allowing human teams to focus on more strategic work. For example, in response to the task 130 (e.g., a user request for customer service(s)), the agentic system 102 creates the plurality of agents 150 to form a chatbot for customer service. In another example, in response to the task 130 (e.g., a user query for SOPs), the agentic system 102 creates the plurality of agents 150 to access existing SOPs for incidents via the database platform 110 and/or the documentation platform 118 and generate a software script that summarizes the existing SOPs. In some embodiments, the agentic system 102 is configured to assemble the plurality of agents 150 as a pipeline (e.g., second pipeline 512 in FIG. 5B) corresponding to the workflow 140 and form an automated process of analyzing the task 130 received from a user (e.g., via the user platform 106). In some embodiments, when the agentic system 102 analyzes the task 130, a respective agent (e.g., agent 150-1) is configured to call another respective agent (e.g., agent 150-2) and exchanges messages and/or to request user input(s) (e.g., via the user platform 106). In some embodiments, when the agentic system 102 analyzes the task 130, a respective agent (e.g., agent 150-1) is configured to receive (e.g., wait for) supervision 134 (e.g., user supervision, user input, user interception, etc.) prior to proceeding to a next step subsequent to a current step of a plurality steps associated with the workflow 140.

In some embodiments, the agentic system 102 of the agentic orchestration platform 100 includes an embedded agentic system. In some embodiments, the embedded agentic system is configured as one of the modalities of the agentic system 102. In some embodiments, the embedded agentic system is developed by a software development kit (SDK) configured as an integrated interface (e.g., command line interface (CLI)) to support application programming interface (API) calls. In some embodiments, the embedded agentic system is extensible across internal/external business and internet processes to perform complex tasks (e.g., for a service company). In some embodiments, the embedded agentic system is configured to be a standalone package (e.g., a self-contained software module) included in the agentic orchestration platform 100. In some embodiments, the embedded agentic system is configured to incorporate AI functionalities (e.g., via the user platform 106, the AI platform 108, the cloud platform 112, and/or the UI platform 120) into new or existing applications (e.g., applications that drive the agentic system 102, applications of the device platform 116). In some embodiments, the embedded agentic system includes one or more plugins that allows new skills and functionalities (e.g., obtained via the user platform 106, the AI platform 108, the database platform 110, the cloud platform 112, the device platform 116, and/or the UI platform 120) be added into the plurality of agents 150 of the agentic system 102.

In some embodiments, the agentic system 102 of the agentic orchestration platform 100 includes a portal agentic system (e.g., illustrated in FIGS. 3-6) configured to deliver key efficiencies by delegating the workflow 140 associated with the task 130 to the plurality of agents 150. In some embodiments, the portal agentic system is configured as one of the modalities of the agentic system 102. In some embodiments, the portal agentic system is configured as a user-friendly workflow-centric terminal (e.g., chatbot) for a user to make calls. In some embodiments, the workflow 140, in whole or in part, is pre-built to leverage built-in automated steps (e.g., an automated step to build a machine learning model via the AI platform 108, an automated step to access a database via the database platform 110, an automated step to acquire documents from the documentation platform 118, etc.). In some embodiments, the AI agentic portal associated with the agentic system 102 includes APIs communicatively coupled (e.g., by wire and/or wireless) to the plurality of functional platforms 104. In some embodiments, the plurality of agents 150 and/or a subset of the plurality of agents 150 are dynamically spawned (e.g., created) using a collection of resources received from and/or stored in the plurality of functional platforms 104 (e.g., the user platform 106, the AI platform 108, the database platform 110, the cloud platform 112, the computing platform 114, the device platform 116, the documentation platform 118, and/or the UI platform 120). In response to generating and transmitting output data to a user, the plurality of agents 150 and/or the subset of the plurality of agents 150 are automatically terminated, thereby releasing the collection of resources utilized during spawning. Stated another way, the spawned plurality of agents 150 and/or subset of the plurality of agents 150 are ephemeral. The agentic system 102 spawns respective agents and executes the task 130 as a process in memory. Once the task 130 is completed and the result 132 is provided to the user, the respective agents are shut down and terminated to release associated computational resources.

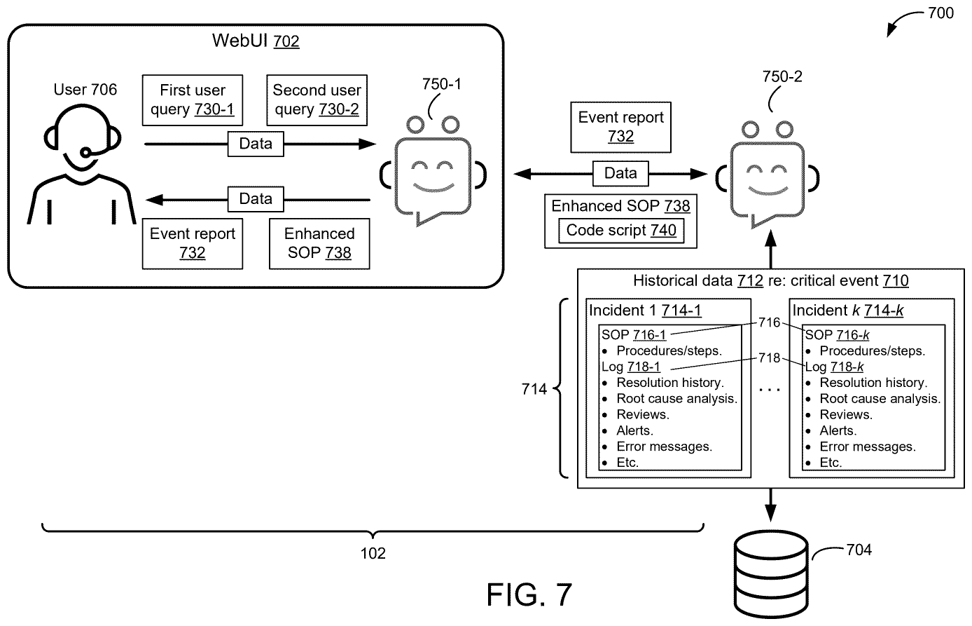

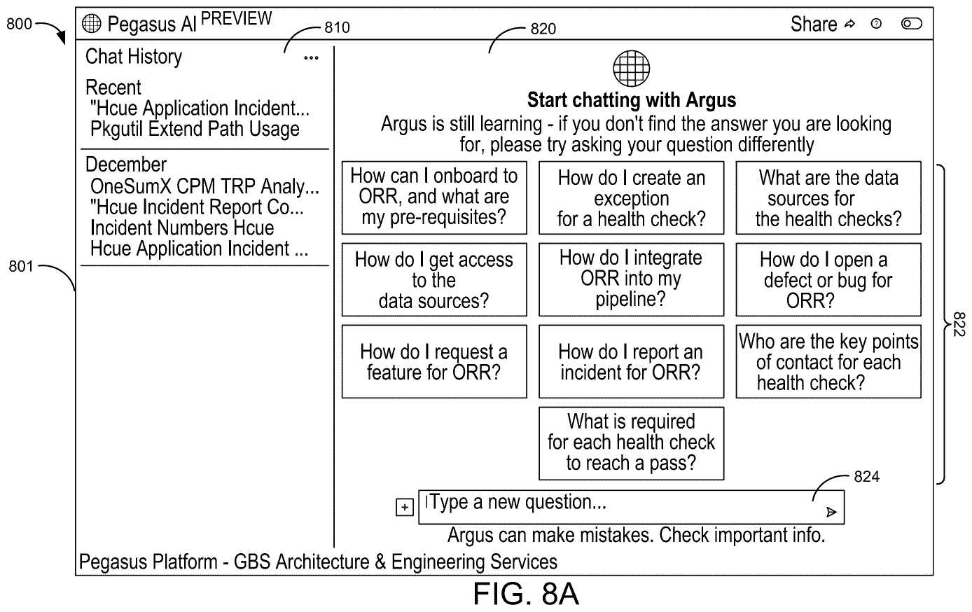

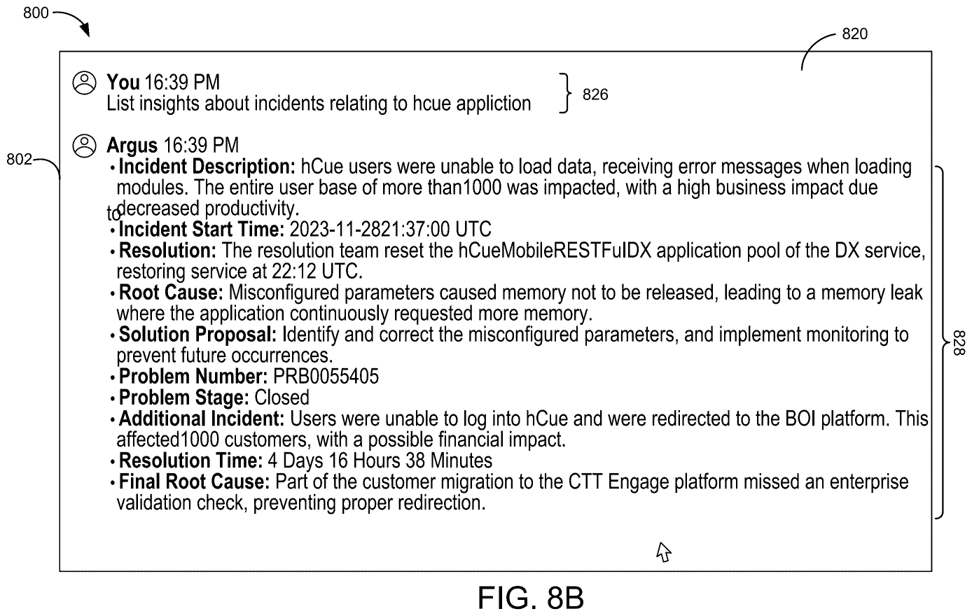

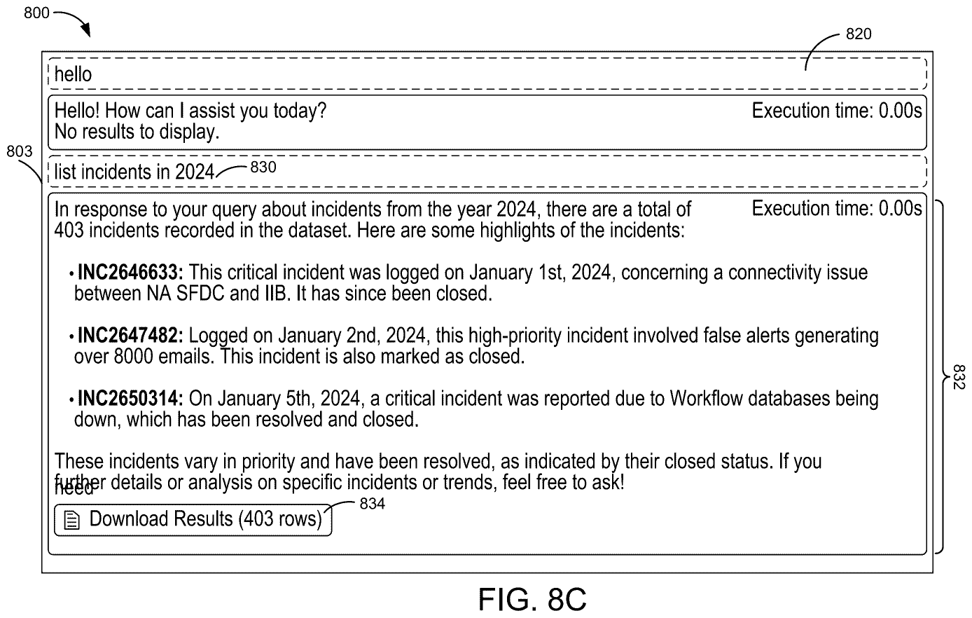

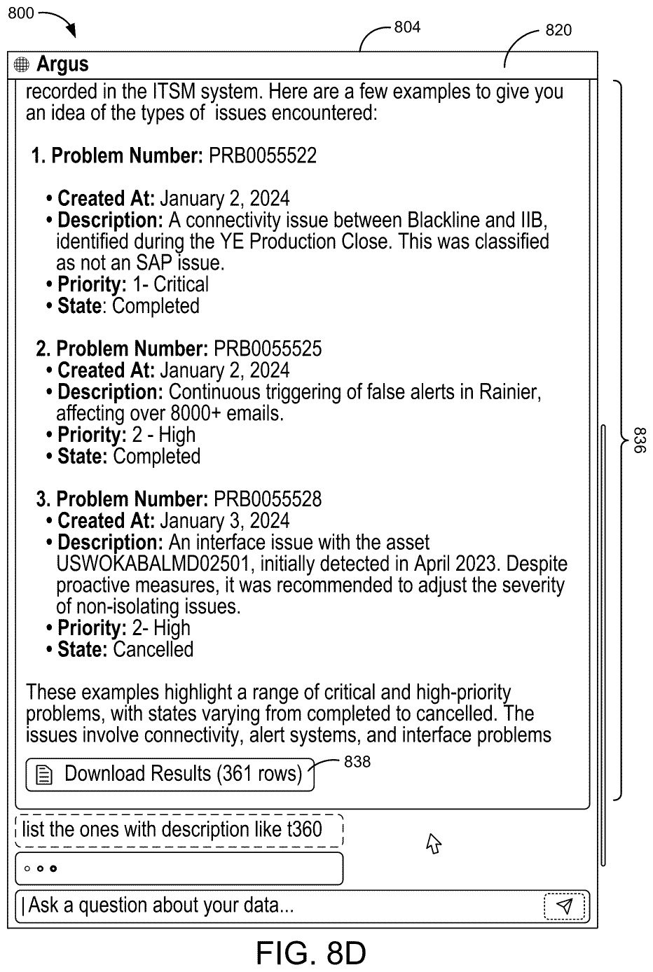

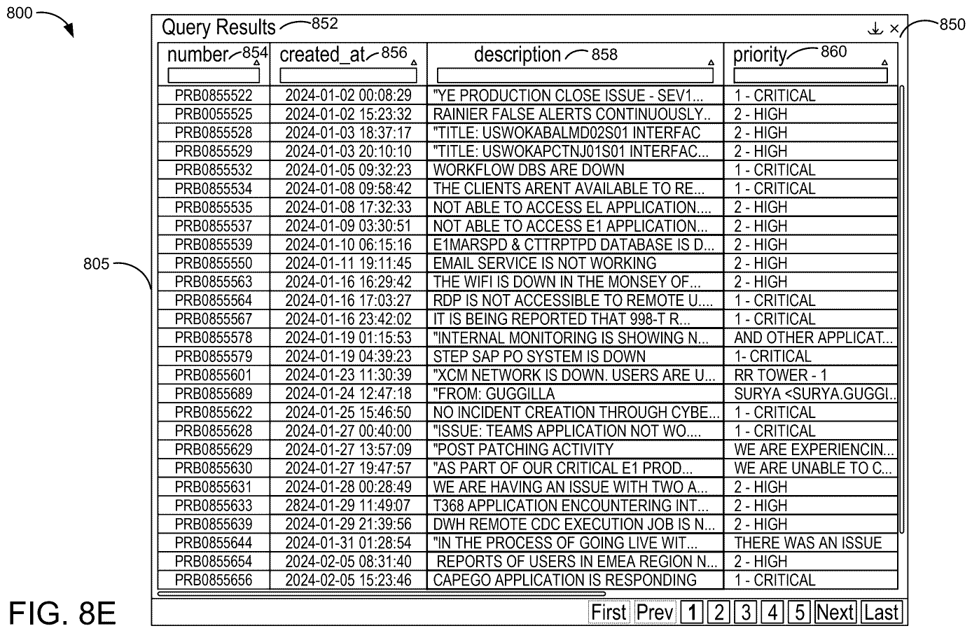

In some embodiments, the agentic system 102 of the agentic orchestration platform 100 includes a web user interface (WebUI) agentic system (e.g., illustrated in FIGS. 7-8E) configured to provide an efficient user interface for user queries. In some embodiments, the WebUI agentic system is configured as one of the modalities of the agentic system 102. In some embodiments, the WebUI agentic system is a self-service and interactive platform that enables users to engage in real-time web-based conversations and chats with the agentic system 102. For example, the WebUI agentic system provides a seamless, user-friendly interface for sending user queries (e.g., searching incident logs, summarizing historical incidents, summarizing standard operating procedures), initiating workflows associated with the user queries, receiving responses (e.g., output data), and interacting with the plurality of agents 150 within a web-based environment.

In some embodiments, the agentic system 102 of the agentic orchestration platform 100 includes an LLM-based agentic system (e.g., an LLM-based framework) configured to enable the plurality of agents 150 to autonomously and adaptively analyze the task 130 by integrating reasoning, learning, and decision-making capabilities. In some embodiments, the LLM-based agentic system is configured as one of the modalities of the agentic system 102. In some embodiments, the agentic system 102 performs autonomous reasoning (e.g., using LLMs). For example, the plurality of agents 150, without supervision, analyze the task 130, perform internal reasoning, and determine optimal actions, thereby reducing the need or the supervision 134. In some embodiments, the agentic system 102 augments human workforce (e.g., using LLMs). For example, the plurality of agents 150 assist human teams (e.g., users of the user platform 106) by leveraging historical data (e.g., received via the database platform and/or the documentation platform 118) related to present incidents (e.g., the task 130), insights and recommendations (e.g., the result 132) to enhance human decision-making and efficiency. In some embodiments, the agentic system 102 implements LLMs to receive the supervision 134 (e.g., from a user via the user platform 106) and analyzes the task 130 corresponding to the supervision 134. For example, the plurality of agents 150 receive the supervision 134 prior to executing an action (e.g., a respective step associated with the workflow 140) that alters a current state, thereby ensuring that critical decisions are reviewed and approved by user(s).

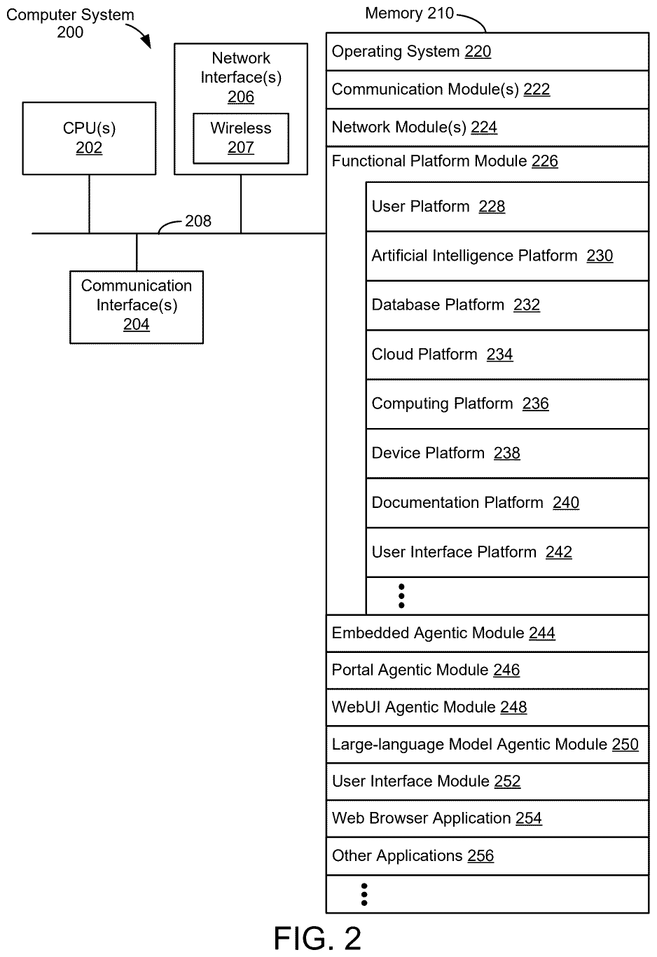

FIG. 2 is a block diagram illustrating a computer system 200 that supports the agentic system 102 (e.g., in reference to FIG. 1), in accordance with some embodiments. The computer system 200 includes one or more central processing units (CPU(s), i.e., processors or cores) 202, one or more communication interfaces 204, one or more network interfaces 206, memory 210, and one or more communication buses 208 for interconnecting these components. The communication buses 208 optionally include circuitry (e.g., a chipset) that interconnects and controls communications between system components.

In some embodiments, the one or more network interfaces 206 include wireless and/or wired interfaces for receiving data from and/or transmitting data to the plurality of functional platforms 104 (e.g., the user platform 106, the AI platform 108, the database platform 110, the cloud platform 112, the computing platform 114, the device platform 116, the documentation platform 118, and/or the UI platform 120) and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 206 include a wireless interface 207 for enabling wireless data communications with the plurality of functional platforms 104 and/or or other wireless (e.g., Bluetooth-compatible) devices (e.g., for displaying data, storing data, processing data, etc.). Furthermore, in some embodiments, the wireless interface 207 (or a different communications interface of the one or more network interfaces 206) enables data communications with other WLAN-compatible components (e.g., devices, servers, clouds, and/or other types) for displaying data, storing data, processing data, or other purposes related to IT operations and agentic orchestration.

Memory 210 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 210 may optionally include one or more storage devices remotely located from the CPU(s) 202. Memory 210, or alternately, the non-volatile memory solid-state storage devices within memory 210, includes a non-transitory computer-readable storage medium. In some embodiments, memory 210 or the non-transitory computer-readable storage medium of memory 210 stores the following programs, modules, and data structures, or a subset or superset thereof:
an operating system 220 that includes procedures for handling various basic system services and for performing hardware-dependent tasks;
communication module(s) 222 for transmitting data (e.g., between the agentic system 102 and the plurality of functional platforms 104, between the plurality of agents 150), handling protocols (e.g., authentication/encryption), detecting error, and/or other functions;
network module(s) 224 for connecting the agentic system 102 to the plurality of functional platforms 104 and/or other devices or systems, via the one or more network interfaces 206 (wired or wireless);
a functional platform module 226 configured to communicate data with the plurality of functional platforms 104. In some embodiments, the functional platform module 226 also includes the following sub-modules (or sets of instructions) associated with the plurality of functional platforms 104, or a subset or superset thereof:
   a user platform sub-module 228 (e.g., for communicating data with the user platform 106);
   an AI platform sub-module 230 (e.g., for communicating data with the AI platform 108);
   a database platform sub-module 232 (e.g., for communicating data with the database platform 110);
   a cloud platform 234 (e.g., for communicating data with the cloud platform 112);
   a computing platform sub-module 236 (e.g., for communicating data with the computing platform 114);
   a device platform sub-module 238 (e.g., for communicating data with the device platform 116);
   a documentation platform sub-module 240 (e.g., for communicating data with the documentation platform 118);
   a UI platform sub-module 242 (e.g., for communicating data with the UI platform 120);
an embedded agentic module 244 (e.g., configured to drive the embedded agentic system of the agentic system 102);
a portal agentic module 246 (e.g., configured to drive the portal agentic system of the agentic system 102);
a WebUI agentic module 248 (e.g., configured to drive the WebUI agentic system of the agentic system 102);
an LLM agentic module 250 (e.g., configured to drive the LLM-based agentic system of the agentic system 102);
a user interface module 252 that receives commands and/or inputs from a user via a user interface (e.g., from an input device) and provides outputs for display on the user interface (e.g., to an output device);
a web browser application 254 for accessing, viewing, and interacting with web sites; and
other applications 256, such as applications for word processing, calendaring, mapping, weather, time keeping, virtual digital assistant, presenting, number crunching (spreadsheets), drawing, instant messaging, e-mail, telephony, video conferencing, photo management, video management, and/or other purposes.

Each of the above identified modules stored in memory 210 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. Likewise, although shown as stored in a single memory, the above-identified modules may be stored on physically separate memories and/or executed on physically separate (e.g., remote) devices. In some embodiments, memory 210 optionally stores a subset or superset of the respective modules and data structures identified above. Furthermore, memory 210 optionally stores additional modules and data structures not described above.

### Agentic Orchestration Platform

FIG. 3 illustrates an example agentic orchestration platform 300, in accordance with some embodiments. In particular, the example agentic orchestration platform 300 implements the agentic system 102 and presents a platform configuration corresponding to the agentic orchestration platform 100 (e.g., in FIG. 1). In some embodiments, the example agentic orchestration platform 300 is configured as the portal agentic system (e.g., one of the modalities of the agentic system 102). In some embodiments, the agentic system 102 is configured as an integrated multi-agent framework configured to reason, learn, execute tasks, and make decisions while communicating and collaborating internally (e.g., between agents) and externally (e.g., with humans/users) to solve tasks (e.g., critical and high-priority incidents, user requests, user queries). In some embodiments, the agentic system 102 generates, based on a user request 330 of a user 306 (e.g., via the user platform 106 in FIG. 1) and by a first agent 350-1, a workflow 140 (in FIG. 1). The workflow 140 includes a plurality of steps 342 (e.g., step 342-1 to step 342-m, where m is an integer greater than two). The agentic system 102 further generates, based on the workflow 140 and by a second agent 350-2, one or more on-demand agents 352 (e.g., first on-demand agent 352-1 to n-th on-demand agent 342-n, where n is an integer greater than one). Each of the plurality of steps 342 is assigned to (e.g., executed by) a respective on-demand agent of the one or more on-demand agents 352. The agentic system 102 further analyzes the workflow 140 by the one or more on-demand agents 352 to generate output data 332. The agentic system 102 further receives user supervision 334 (e.g., supervision 134 in FIG. 1) associated with the output data 332 by the first agent 350-1. The agentic system 102 further determines, based on the user supervision 334 and by the second agent 350-2, whether the output data 332 requires updating. In accordance with a determination that the output data 332 requires updating, the agentic system 102 further updates the output data 332 to form updated output data 332′. The agentic system 102 further displays the updated output data 332 to the user 306 (e.g., on a display device via the user platform 106 and/or the device platform 116).

In some embodiments, each agent of the first agent 350-1, the second agent 350-2, and the one or more on-demand agents 352 is driven by a respective computational component from a plurality of computational components (e.g., data analytics, analytical models, machine-learning models, LLMs, plugins, other types of models, or a combination of various types). In some embodiments, the plurality of computational components are built using a combination of resources received from and/or stored in the plurality of functional platforms 104 (e.g., the user platform 106, the AI platform 108, the database platform 110, the cloud platform 112, the computing platform 114, the device platform 116, the documentation platform 118, and/or the UI platform 120). In some embodiments, the plurality of computational components include at least one of the group consisting of (i) an analytical model (e.g., regression model, decision tree, clustering, etc.), (ii) an LLM (e.g., deep learning models, natural language processing, etc.), and (iii) a plugin (e.g., query plugin, automation plugin, chatbot plugin, knowledge base integration, etc.).

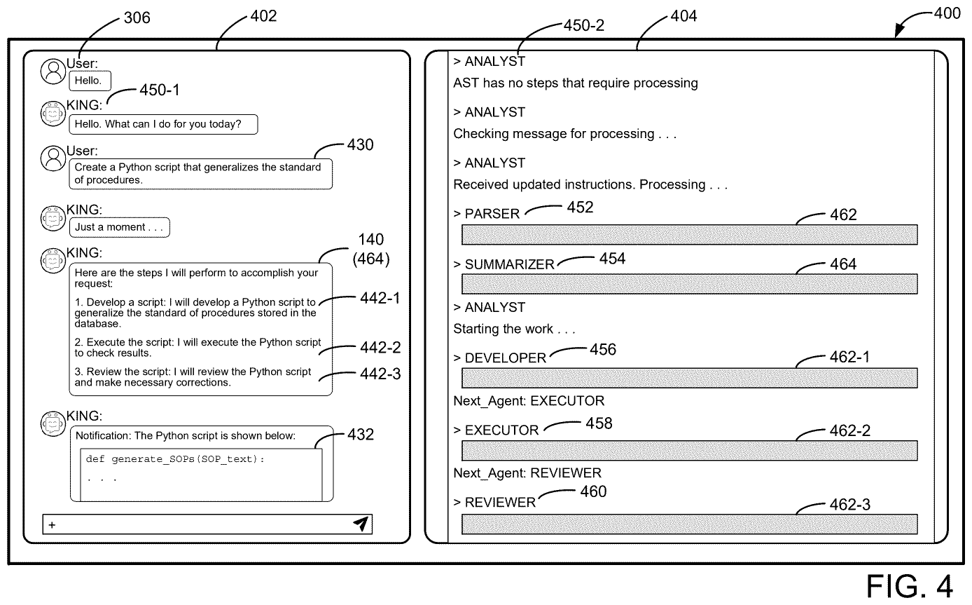

In some embodiments, the first agent 350-1 is an external agent (e.g., an externally-facing agent, such as agent “KING” 450-1 in FIG. 4) configured to communicate data with the user 306 and the second agent 350-2. In some embodiments, the first agent 350-1 is dynamically created (e.g., on an as-needed basis, on-demand) based on the user request 330 using resources provided in the plurality of functional platforms 104. For example, when the user request 330 includes a critical and high-priority incident, the first agent 350-1 is created on an as-needed basis to analyze the incident to generate the workflow 140. In some embodiments, the first agent 350-1 is hard-coded. For example, the first agent 350-1 is a hard-coded model (e.g., a script to generate workflow(s), an API to an LLM, an LLM plugin) independently built regardless of the type of the user request 330.

In some embodiments, the second agent 350-2 is an internal agent (e.g., internally-facing agent, such as agent “ANALYST” 450-2 in FIG. 4) configured to communicate data with the first agent 350-1 and supervise (e.g., coordinate) the one or more on-demand agents 352 based on the workflow 140. In some embodiments, the second agent 350-2 is dynamically created (e.g., on an as-needed basis, on-demand) by the first agent 350-1 using resources provided in the plurality of functional platforms 104. For example, when the first agent 350-1 identifies the workflow 140 from the user request 330 and determines that it is capable of processing the workflow 140 (e.g., due to excessive computation resources required by the first agent 350-1, a need for specific model(s) and/or data analytics that the first agent 350-1 does not support) creates the second agent 350-2 on an as-needed basis to process the workflow 140. In some embodiments, the second agent 350-2 is hard-coded. For example, the second agent 350-2 is a hard-coded model (e.g., a script to process workflow(s), an API to an LLM, an LLM plugin) independently built regardless of the type of the user request 330.

In some embodiments, the second agent 350-2 is in compliance with a remote procedure call (RPC) framework for external functions. In particular, the RPC framework allows the agentic system 102 to execute functions and/or procedures located on external systems/platforms (e.g., the plurality functional platforms 104) as if they were local. Moreover, the RPC framework provides libraries and protocols for creating communication channels, performing serialization, and handling errors. In some embodiments, the second agent 350-2 implements a gRPC Remote Procedure Call framework.

In some embodiments, the one or more on-demand agents 352 are dynamically created (e.g., on an as-needed basis, on-demand) by the second agent 350-2 using resources provided in the plurality of functional platforms 104. In some embodiments, a respective on-demand agent (e.g., the second on-demand agent 352-2) of the one or more on-demand agents 352 is dynamically created by another respective on-demand agent (e.g., the first on-demand agent 352-1) of the one or more on-demand agents 352 using resources provided in the plurality of functional platforms 104. For example, when the first on-demand agent 352-1 identifies, based on the step 342-1, that a subsequent step 342-2 exists and needs to be processed, the first on-demand agent 352-1 creates the second on-demand agent 352-2 to execute the step 342-2. In some embodiments, a respective on-demand agent (e.g., the first on-demand agent 352-1) is configured to create another respective on-demand agent (e.g., the second on-demand agent 352-2) using resources provided in the plurality of functional platforms 104. In some embodiments, a subset of the one or more on-demand agents 352 are hard-coded.

In some embodiments, the user request 330 is a task (e.g., task 130 in FIG. 1, such as a request to resolve critical and high-priority incident, a request to access a database, a request to create a SOP based on a pool of SOPs). In some embodiments, the user request 330 is configured as a user query based on the task (e.g., task 130 in FIG. 1). The first agent 350-1 receives the user query (e.g., a natural language query, a data query) associated with the user request 320 from the user 306. The first agent 350-1 further identifies, based on the user query, a user intent (e.g., in forms of word embeddings). The first agent 350-1 further creates, based on the user intent, the workflow 140 (e.g., by comparing word embeddings). In some embodiments, the output data 332 are included in a result (e.g., result 132 in FIG. 1, such as recommendations/solutions to a critical and high-priority incident, summaries of historical incidents, scripts for generating SOPs) for the user 306.

In some embodiments, the workflow 140 defines, based the user request 330, a process to generate the output data 332 and the updated output data 332′. In particular, the plurality of steps 342 define specific actions/activities for generating a target output for the user 306, which are executed by the one or more on-demand agents 352. In some embodiments, each of the plurality of steps 342 is assigned to (e.g., executed by) a respective on-demand agent (e.g., the first on-demand agent 352-1) that is distinct from remaining on-demand agent(s) of the respective on-demand agent (e.g., the first on-demand agent 352-1). Stated another way, each of the one or more on-demand agents 352 is distinct from each other. In some embodiments, one or more steps (e.g., the step 342-1 and the step 342-2) are assigned to (e.g., executed by) the same on-demand agent (e.g., the first on-demand agent 352-1).

In some embodiments, the workflow 140 includes a schema. In particular, the schema is easily parsed and processed by the agentic system 102, thereby providing various advantages such as consistency, automation, scalability, adaptability, visualization and more. In some embodiments, the schema is in form of a JavaScript Object Notation (JSON) (e.g., the workflow 140 is a JSON file). In some embodiments, the first agent 350-1 parses the user request 330 (e.g., breaking a text query into words, phrases, or symbols) to generate an abstract syntax tree (AST). The first agent 350-1 further analyzes the AST to identify the plurality of steps 342. The first agent 350-1 further generates the schema based on the plurality of steps 342.

In some embodiments, each of the plurality of steps 342 (e.g., the steps 342-1, 342-2, . . . 342-m) includes a respective task message (e.g., in format of a Gherkin statement, a schema, or other type) identifying a respective task. In some embodiments, a respective task is configured as a sub-task of the user request 330 and defines a corresponding step to be performed. In some embodiments, for each of the plurality of steps 342, the second agent 350-2 analyzes the respective task message, and identifies, based on the analyzed respective task message, the respective on-demand agent. The respective on-demand agent processes the respective task to generate respective data. In particular, the respective data generated by the respective on-demand agent is used by the second agent 350-2 to generate the output data 332 (e.g., the respective data are part of the output data 332).

In some embodiments, the agents (e.g., the first agent 350-1, the second agent 350-2, and/or the one or more on-demand agents 352) communicate internally through communication messages (e.g., in format of a schema). In some embodiments, respective data generated by a respective on-demand agent include a respective communication message (e.g., in format of a schema) for another respective on-demand agent that processes another respective task subsequent to the respective task. Stated another way, the respective communication message is configured as an instruction for the other on-demand agent to follow when processing the other respective task subsequent to the respective task. For example, the respective data 362-1 (e.g., Python scripts) generated by the first on-demand agent 352-1 (e.g., agent “DEVELOPER” 456 in FIG. 4) include a respective communication message that has an indication that the respective data 362-1 needs to be executed and/or other information (e.g., code language, code length, process priority, etc.) associated with the respective data 362-1. When the second on-demand agent 352-2 (e.g., agent “EXECUTOR” 458 in FIG. 4) receives the respective data 362-2, the second on-demand agent 352-2 processes the respective task of the step 342-2, which is subsequent to the respective task of the step 342-1, in accordance with the respective communication message of the respective data 362-1. In another example, the respective data 362-2 (e.g., executed Python scripts) generated by the second on-demand agent 352-2 (e.g., agent “EXECUTOR” 458 in FIG. 4) include a respective communication message that have an indication that the respective data 362-2 needs to be reviewed and/or other information (e.g., code language, number of the reviewed Python scripts, target length of a consolidated script, process priority, etc.) associated with the respective data 362-2. When the third on-demand agent 352-3 (e.g., agent “REVIEWER” 460 in FIG. 4) receives the respective data 362-2, the third on-demand agent 352-3 processes the respective task of the step 342-3, which is subsequent to the respective task of the step 342-2, in accordance with the respective communication message of the respective data 362-2.

In some embodiments, the agentic system 102 receives supervision (e.g., user supervision, user input, user interception) to make more effective decisions and ensure safety and accuracy. In some embodiments, the first agent 350-1 of the agentic system 102 receives the user supervision 334 associated with the output data 332. In particular, the user supervision 334 is configured as a user input or a user interception that provides feedback (e.g., error detection, performance metrics, real-time monitoring, operational feedback, auditing/compliance check, user satisfaction) to the output data 332 and is used to determine whether the output data 332 requires updating. In some embodiments, the first agent 350-1 of the agentic system 102 displays the output data 332 to the user 306, and receives a user input 336 (e.g., a user query, a textual input, etc.) including the user supervision 334 that identifies a correctness of the output data 332. Stated another way, the first agent 350-1 receives the user input 336 including the user supervision 334 after the output data 332 is shown (e.g., displayed via the user platform 106 and/or the UI platform 120) to the user 306. In some embodiments, the correctness of the output data 332 is determined by a plurality of factors, including but not limited to precision, consistency, error rate, relevance, data integrity, and robustness. In some embodiments, the user supervision 334 includes a user input to accept or reject the output data 332. When the user input rejects the output data 332, the agentic system 102 updates the output data 332 to form updated output data 332′ (e.g., a new set of data) for receiving another user supervision. In some embodiments, the user supervision 334 includes a user approval (e.g., authorization) and a user rejection. For example, before an agent (e.g., the agent “EXECUTOR” 458 in FIG. 4) executes a code script created by another agent (e.g., agent “DEVELOPER” 456 in FIG. 4), the agentic system 102 receives a user authorization to proceed with executing the code script by the other agent. In some embodiments, the user supervision 334 includes a two-fold supervision: (i) a user reviews and provides clarifications and (ii) a user authorizes an execution for an agent to execute a respective task.

In some embodiments, the second agent 350-2 receives the user input 336 having the user supervision 334 via the first agent 350-1 and determines, based on the user supervision 334, the user input 336, whether the output data 332 requires updating. In some embodiments, the determination of whether the output data 332 requires updating corresponds to the correctness of the output data 332 identified by the user supervision 334. In some embodiments, the determination of whether the output data 332 requires updating includes determining a respective on-demand agent of the one or more on-demand agents 352 that is responsible for updating the output data 332. In particular, the second agent 350-2 identifies a respective on-demand agent associated with the user supervision 334. The respective on-demand agent determines, based on the user supervision 334, whether the output data 332 requires updating. Stated another way, in some embodiments, the agentic system 102 is configured to identify which agent (e.g., on-demand agent) is responsible for analyzing the user supervision 334. For example, when the user supervision 334 identifies that the output data 332 (e.g., a consolidated script to generate a unified SOP) was not correctly generated due to the use of incorrect SOPs and the second agent 350-2 identifies that the on-demand agent 342-1 (e.g., agent “DEVELOPER” 456 in FIG. 4) is associated with the user supervision 334, the on-demand agent 342-1 determines, based on the user supervision 334, that the respective data 362-1 requires updating because wrong SOPs were used. As such, the output data 332 is updated to form the updated output data 332′. In another example, when the user supervision 334 identifies that the output data 332 (e.g., a unified SOP) contains grammatical errors and the second agent 350-2 identifies that the on-demand agent 342-3 (e.g., agent “REVIEWER” 460 in FIG. 4) is associated with the user supervision 334, the on-demand agent 342-3 determines, based on the user supervision 334, that the respective data 362-3 requires updating because the grammatical errors need corrections. As such, the output data 332 is updated to form the updated output data 332′.

In some embodiments, in response to receiving the user supervision 334 (or the user input 336 including the user supervision 334), the second agent 350-2 determines, based on the user supervision 334, whether the output data 332 requires updating. Stated another way, in some embodiments, receiving the user supervision 334 from the user 306 is a prerequisite for updating the output data 332. In some embodiments, receiving the user supervision 334 from the user 306 is optional. In this situation, no update to the output data 332 is required.

In some embodiments, the user supervision 334 initiates an update to a respective on-demand agent of the one or more on-demand agents 352. Stated another way, a respective on-demand agent is updated based on the user supervision 334. In particular, when the second agent 350-2 identifies that a respective on-demand agent is associated with the user supervision 334, the second agent 350-2 updates the respective on-demand agent. For example, when the user supervision 334 indicates that the output data 332 were not properly generated due to the use of incorrect model(s) and the second agent 350-2 identifies that the on-demand agent 342-1 (e.g., agent “DEVELOPER” 456 in FIG. 4) is associated with the user supervision 334, the second agent 350-2 is configured to update the on-demand agent 342-1 (e.g., rebuilding the on-demand agent 342-1 using updated model(s), tuning existing model(s) used by the on-demand agent 342-1). As such, the on-demand agent 342-1 is updated, thereby updating the respective data 362-1 and the output data 332 to form the updated output data 332′.

In some embodiments, the agentic system 102 implements an iterative process to receive the user supervision 334 for updating the output data 332. In particular, the agentic system 102 iteratively receives respective user supervision associated with respective output data by the first agent 350-1, determines, based on the respective user supervision and by the second agent 350-2, whether the respective output data requires updating, and in accordance with a determination that the respective output data requires updating, updating the respective output data. Stated another way, in some embodiments, updating the output data 332 requires one or more feedback loops 338, and each of the one or more feedback loops 338 corresponds to respective output data and respective user supervision. The iterative process, driven by the one or more feedback loops 338, enables the agentic system 102 to operate under supervision, ensuing decision-making and adaptability in complex, dynamic environments associated with the user request 330.

FIG. 4 illustrates an example UI 400 built for the agentic system 102, in accordance with some embodiments. In some embodiments, the example UI 400 functions as a user interface (e.g., a chatbot) for the example agentic orchestration platform 300. In some embodiments, the example UI 400 is configured as a user interface for the portal agentic system (e.g., one of the modalities of the agentic system 102). In some embodiments, the example UI 400 is part of the user platform 106, the device platform 116, and/or the UI platform 120. In some embodiments, the example UI 400 is configured to display user request(s), user supervision, and output data to the user 306.

As shown in FIG. 4, the example UI 400 includes a first panel 402 and a second panel 404. In some embodiments, the first panel 402 displays interactions between the user 306 and an agent “KING” 450-1. The second panel 404 displays interactions between agents including the agent “KING” 450-1, an agent “ANALYST” 450-2, an agent “PARSER” 452, an agent “SUMMARIZER” 454, an agent “DEVELOPER” 456, an agent “EXECUTOR” 458, an agent “REVIEWER” 460. In some embodiments, the second panel 404 of the example UI 400 is hidden and not shown to the user 306. In some embodiments, the agent “KING” 450-1 and the agent “ANALYST” 450-2 are configured as the first agent 350-1 and the second agent 350-2, respectively. In some embodiments, the agent “DEVELOPER” 456, the agent “EXECUTOR” 458, and the agent “REVIEWER” 460 are configured as on-demand agents (e.g., the one or more on-demand agents 352).

In some embodiments, as shown in the example UI 400, the agentic system 102 generates, based on a user request 430 (e.g., “create a Python script that generalizes the standard of procedure”) of the user 306 and by the agent “KING” 450-1, a workflow 140. The workflow 140 includes a plurality of steps 442 (e.g., steps 442-1, 442-2, and 442-3). The agentic system 102 further generates, based on the workflow 140 and by the agent “ANALYST” 450-2, the agents “DEVELOPER” 456, “EXECUTOR” 458, and “REVIEWER” 460. Each of the plurality of steps 442 is assigned to (e.g., executed by) a respective agent of the agents “DEVELOPER” 456, “EXECUTOR” 458, and “REVIEWER” 460. For example, the steps 442-1, 442-2, and 442-3 are assigned to (e.g., executed by) the agents “DEVELOPER” 456, “EXECUTOR” 458, and “REVIEWER” 460, respectively. The agentic system 102 further analyzes the workflow 140 by the agents “DEVELOPER” 456, “EXECUTOR” 458, and “REVIEWER” 460 to generate output data 432 (e.g., a Python script).

In some embodiments, each of the plurality of steps 442 includes a respective task message identifying a respective task. For example, the step 442-1 includes a first respective task message “develop a script,” the step 442-2 includes a second respective task message “execute a script,” and the step 442-3 includes a third respective task message “review a script.” In some embodiments, for each of the plurality of steps 442, the agent “ANALYST” 450-2 analyzes the respective task message, and identifies, based on the analyzed respective task message, the respective agent. The respective agent processes the respective task to generate respective data. In particular, the respective data generated by the respective agent is used by the agent “ANALYST” 450-2 to generate the output data 432 (e.g., a Python script). For example, when the agent “ANALYST” 450-2 analyzes the respective message “develop a script” of the step 442-1 and determines that the step 442-1 requires developing a Python script based on a series of SOPs, the agent “ANALYST” 450-2 identifies the agent “DEVELOPER” 456 to process the respective task of the step 442-1 (e.g., creating a Python script based on the series of SOPs by consolidating the series of SOPs into a single script) for generating respective data 462-1 as part of the output data 432. In another example, when the agent “ANALYST” 450-2 analyzes the respective message “execute the script” of the step 442-2 and determines that the step 442-2 requires executing the Python script, the agent “ANALYST” 450-2 identifies the agent “EXECUTOR” 458 to process the respective task of the step 442-2 (e.g., executing the Python script) for generating respective data 462-2 (e.g., a unified SOP) as part of the output data 432. In yet another example, when the agent “ANALYST” 450-2 analyzes the respective message “review the script” of the step 442-3 and determines that the step 442-3 requires reviewing the Python script and/or the unified SOP generated by the Python script, the agent “ANALYST” 450-2 identifies the agent “REVIEWER” 460 to process the respective task of the step 442-2 (e.g., detecting error(s) and validating the Python script) for generating respective data 462-2 (e.g., a reviewed Python script with necessary corrections) as part of the output data 432.

In some embodiments, the agentic system 102 generates an agent “PARSER” 452 and an agent “SUMMARIZER” 454. In some embodiments, the agent “PARSER” 452 and the agent “SUMMARIZER” 454 are included in the agent “KING” 450-1. In some embodiments, the agent “PARSER” 452 parses the user request 330 (e.g., breaking a text query into words, phrases, or symbols) to generate an abstract syntax tree (AST). The agent “PARSER” 452 further analyzes the AST to identify the plurality of steps 342. The agent “PARSER” 452 further generates a schema 462 based on the plurality of steps 342. In some embodiments, agent “SUMMARIZER” 454 generates a summary 464 based on the schema 462. In some embodiments, the agent “KING” 450-1 displays the summary 464 (e.g., the workflow 140) to the user 306 via the example UI 400.

### Incident Management: Pipeline

FIG. 5A illustrates an example incident management framework 500 that does not implement the agentic system 102, and FIG. 5B illustrates another example incident management framework 510 that implements the agentic system 102, in accordance with some embodiments. The example incident management frameworks 500 and 510 include a first pipeline 502 and a second pipeline 512, respectively, for resolving an incident 530 (e.g., a critical and high-priority incident). In some embodiments, each of the first pipeline 502 and the second pipeline 512 is part of the workflow 140 and identifies the steps. In some embodiments, the incident 530 is included in the task 130 and/or the user request 330. Compared with the example incident management framework 500, the example incident management framework 510 is AI-augmented and built based on the agentic system 102. Stated another way, the first pipeline 502 is executed only by humans, and the second pipeline 512 is executed by human(s) and agents. In some embodiments, the example incident management framework 510 is operated based on the portal agentic system (e.g., one of the modalities of the agentic system 102).

In some embodiments, as shown in FIG. 5A, the first pipeline 502 includes six steps: step 0, step 1 (e.g., step 542-1), step 2 (e.g., step 542-2), step 3 (e.g., step 542-3), step 4 (e.g., step 542-4), and step 5 (e.g., step 542-5). The step 0 is configured to create the incident 530, which is executed by one user (e.g., a helpdesk supporter). The step 1 (e.g., step 542-1) is configured to convene an incident bridge, which is executed by approximately one user (e.g., an incident manager). The step 2 (e.g., step 542-2) is configured to investigate issues corresponding to the user request 330, which is executed by approximately seven users (e.g., subject matter experts (SMEs)). The step 3 (e.g., step 542-3) is configured to develop (e.g., generate) mitigation plan(s) and documentation(s) (e.g., SOP(s)), which is executed by approximately three users (e.g., SMEs). The step 4 (e.g., step 542-4) is configured to execute the generated mitigation plan(s) and documentation(s) and make corrective action(s), which is executed by approximately one user (e.g., SME). The step 5 (e.g., step 542-5) is configured to review (e.g., validate) the generated mitigation plan(s) and documentation(s) and restore service(s), which is executed by approximately three users (e.g., SMEs).

As discussed above, the first pipeline 502 is executed only by humans (e.g., users such as helpdesk supporter(s), incident manager(s), and SMEs). TABLE I illustrates approximately durations associated with each step in the example incident management framework 500. A total duration required to resolve the incident 530 and restore service(s) is intoxicatedly 5 hours 15 mins.

TABLE I

| Number | Steps | Role | Approx. Duration | |
|---|---|---|---|---|
| 0 | Incident Creation | Helpdesk Supporter | 15 | mins |
| | | (e.g., one (1) user) | | |
| 1 | Incident Bridge Convened | Incident Manager | 15 | mins |
| | (e.g., step 542-1) | (e.g., one (1) user) | | |
| 2 | Issue Investigation | Subject Matter Experts | 2 | hours |
| | (e.g., step 542-2) | (e.g., seven (7) users) | | |
| 3 | Mitigation Plan & | Subject Matter Experts | 45 | mins |
| | Documentation | (e.g., three (3) users) | | |
| | (e.g., step 542-3) | | | |
| 4 | Corrective Action & Execution | Subject Matter Expert | 1 hour 30 mins | |
| | (e.g., step 542-4) | (e.g., one (1) user) | | |
| 5 | Validation & Service Restored | Subject Matter Experts | 30 | mins |

| | |
|---|---|
| (e.g., step 542-5) | (e.g., three (3) users) |

| | |
|---|---|
| Total Duration from Incident to Restoration | 5 hours 15 mins |

In some embodiments, as shown in FIG. 5B, the second pipeline 512 also includes six steps: step 0, step 1 (e.g., step 542-1), step 2 (e.g., step 542-2), step 3 (e.g., step 542-3), step 4 (e.g., step 542-4), and step 5 (e.g., step 542-5), similar to those steps included in the first pipeline 502. Different from the first pipeline 502, a majority of the steps of the second pipeline 512 are executed by agents of the agentic system 102. In particular, the agentic system 102 includes a plurality of on-call agents 552 (e.g., first on-call agent 552-1, second on-call agent 552-2, third on-call agent 550-3, fourth on-call agent 552-4, and fifth on-call agent 552-5) for executing the steps 542-1 to 542-5. Each of the plurality of on-call agents 552 executes a corresponding step in accordance with the second pipeline 512. For example, the first on-call agent 552-1 executes the step 542-1 to convene an incident bridge. In another example, the fifth on-call agent 552-5 executes the step 542-5 to review (e.g., validate) the generated mitigation plan(s) and documentation(s) and restore service(s). In some embodiments, two or more respective steps (e.g., the steps 542-1 and 542-3) are assigned to the same on-call agent (e.g., the first agent 550-1), such that the first on-agent 552-1 replaces the second on-agent 552-2 and the second on-agent 552-2 is no longer needed. In some embodiments, a respective step (e.g., steps 542-1) is assigned to one or more on-call agents. For example, the first on-call agent 552-1 includes two on-call agents for executing the step 552-1. In some embodiments, the plurality of on-call agents 552 and the one or more on-demand agents 352 are exchangeable, and they are part of the plurality of agents 150 (in FIG. 1).

As discussed above, the second pipeline 512 is executed by human(s) and five on-call agents 552-1 to 552-5. TABLE II illustrates approximately durations associated with each step in the example incident management framework 510. A total duration required to resolve the incident 530 and restore service(s) is approximately 1 hour 50 mins, which is significantly less than the approximate duration of 5 hours 15 mins required by the example incident management framework 500.

TABLE II

| Number | Steps | Role | Approx. Duration | |
|---|---|---|---|---|
| 0 | Incident Creation | A human (e.g., | 15 | mins |
| | | Helpdesk Supporter) | | |
| | | (e.g., one (1) user) | | |
| 1 | Incident Bridge Convened | Human and an agent | 15 | mins |
| | (e.g., step 542-1) | (e.g., one (1) user) | | |
| 2 | Issue Investigation | An agent | 30 | mins |
| | (e.g., step 542-2) | (e.g., zero (0) user) | | |
| 3 | Mitigation Plan & | An agent | 15 | mins |
| | Documentation | (e.g., zero (0) user) | | |
| | (e.g., step 542-3) | | | |
| 4 | Corrective Action & Execution | An agent | 30 | mins |
| | (e.g., step 542-4) | (e.g., zero (0) user) | | |
| 5 | Validation & Service Restored | A human and an agent | 15 | mins |

| | |
|---|---|
| (e.g., step 542-5) | (e.g., one (1) user) |

| | |
|---|---|
| Total Duration from Incident to Restoration | 1 hour 50 mins |

In some embodiments, the example incident management framework 510 operates under supervision (e.g., user supervision, user input, user interception, etc.), similar to the example agentic orchestration platform 300 (in FIG. 3). For example, in the step 3 (e.g., step 542-3), the third on-call agent 552-3 develops (e.g., generates) mitigation plan(s) and documentation(s) (e.g., SOP(s)) as part of output data 532. The output data 532 is displayed to a user (e.g., the user 506 and/or other human(s)). The agentic system 102 receives first user supervision 534-1 (e.g., an agent-human interaction) for determining whether the output data 532 requires updating. In accordance with a determination by the fourth on-call agent 552-4 that the output data 532 requires updating, fourth on-call agent 552-4 updates the output data 532 to generate updated output data 534. In another example, in the step 5 (e.g., step 542-5), the fifth on-call agent 552-5 reviews (e.g., validates) the updated output data 534 (e.g., updated mitigation plan(s) and documentation(s)) and restore service(s). The agentic system 102 receives second user supervision 534-2 (e.g., an instruction from the user 506 and/or other human(s) indicating how to display the updated output data 534). The agentic system 102 displays (e.g., by the fifth on-call agent 552-5) the updated output data 534 to the user 506 in accordance with the second user supervision 534-2.

In some embodiments, the plurality of on-call agents 552 are dynamically created (e.g., on an as-needed basis, on-demand) using resources provided in the plurality of functional platforms 104. For example, when the agentic system 102 identifies a need to convene an incident bridge based on message(s) carried by the incident 530, the agentic system 102 dynamically creates the first on-call agent 552-1 to execute the step 542-1. In another example, when the first on-call agent 552-1 identifies a need to execute a subsequent step (e.g., the step 542-2) that requires an agent to search for issue from knowledgebase based on incident parameters, the first on-call agent 552-1 dynamically creates the second on-call agent 552-2 to execute the step 542-2. In some embodiments, the first on-call agent 552-1 is hard-coded, because it would be certain that at least one on-call agent is needed to resolve the incident 530.

In some embodiments, a respective on-call agent (e.g., the first on-call agent 552-1) of the plurality of on-call agents 552 is a central on-call agent and remaining agents (e.g., the second to fifth on-call agents 552-2 to 552-5) of the plurality of on-call agents 552 are non-central on-call agents. For example, the central on-call agent (e.g., agent 552-1) is configured to communicate externally with the user 506 to receive the incident 530, generate the second pipeline 512 (e.g., the workflow 140) based on the incident 530, coordinate (e.g., orchestrate) the non-central on-call agents to analyze the incident 530 to generate data (e.g., the output data 532 and/or the updated output data 534), and send the data to the user 506. In another example, the central on-call agent (e.g., agents 552-1) dynamically creates the non-central on-call agents (e.g., agents 552-2 to 552-5) using a combination of resources provided in the plurality of functional platforms 104 (e.g., creating a respective on-call agent as needed using resources provided by the AI platform 108, the cloud platform 112, and the computing platform 114 in FIG. 1).

### Incident Management: Spawning and Terminating Agents

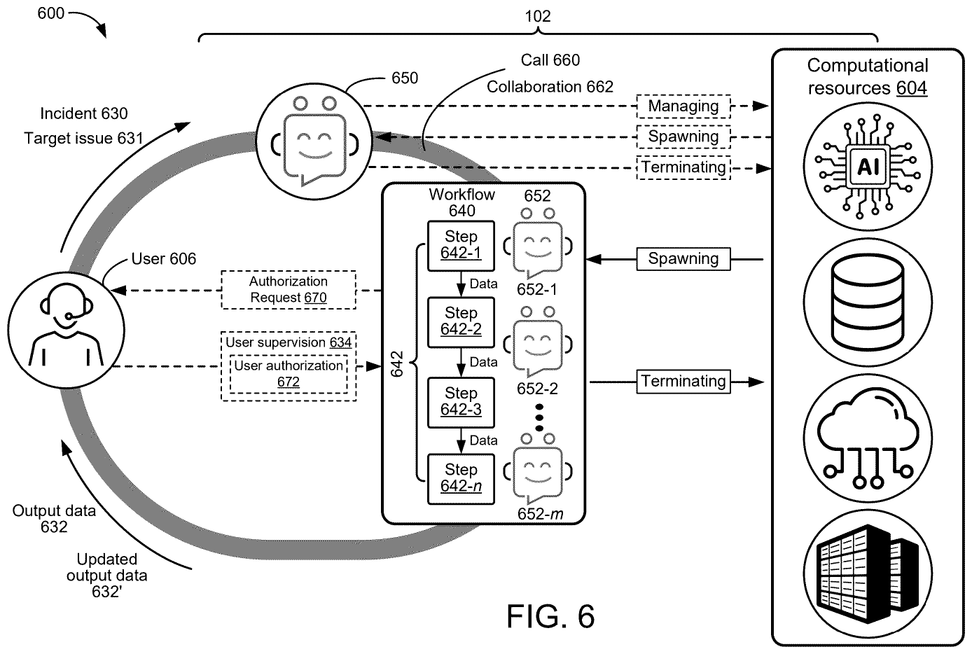

FIG. 6 illustrates an example incident management framework 600 that implements the agentic system 102, in accordance with some embodiments. In particular, the example incident management framework 600 facilitates dynamically spawning and automatically terminating agents (e.g., on-call agents), thereby enhancing operational efficiency, responsiveness, and sustainability of the agentic system 102. For example, the capability of dynamically spawning and automatically terminating agents ensures that computational resources (e.g., resource of functional platforms 104 in FIG. 1) are allocated only when needed, preventing idle agents (e.g., agents who have accomplished assigned tasks) from consuming memory, CPUs, or storages. In another example, this dynamic configuration enables the agentic system 102 to scale efficiently based on real-time incident management demands. During peak loads, the agentic system 102 is configured to spawn additional agents to maintain optimal performance, while during low loads, the agentic system 102 is configured to terminate idle agents (e.g., agents who have accomplished assigned tasks) to conserve computational resources. In yet another example, automatically terminating agents allows for minimization of superfluous computational resource consumption particularly in cloud-based environments. In some embodiments, the example incident management framework 600 is operated based on the portal agentic system (e.g., one of the modalities of the agentic system 102). In some embodiments, the example incident management framework 600 is similar to the example incident management framework 510, each of which is AI-augmented and built based on the agentic system 102. In some embodiments, on-call agents and on-demand agents are exchangeable.

In some embodiments, as shown in FIG. 6, the agentic system 102 receives, from a user 606 (e.g., a human who creates an incident based on an internal/external customer's input), an incident 630 defining a target issue 631 to be addressed. For example, the incident 630 includes a critical and high-priority incident that requires an immediate attention from the agentic system 102. In this circumstance, the incident 630 defines the target issue 631 as the resolutions of errors (e.g., data errors, access errors, configuration errors, etc.) or failures (e.g., network failures, API failures, cloud service outages, domain secure session setup failures, etc.). In another example, the incident 630 includes an operation that requires processing (e.g., model training, data searching, etc.) via the agentic system 102. In this circumstance, the incident 630 defines the target issue 631 as the execution of the operation. The agentic system 102 further convenes in real-time, based on the incident 630 and by a coordinating agent 650, a call 660 that defines a collaboration 662. For example, the call 660 is convened without an intentionally introduced lag by the agentic system 102 or the user 606. In another example, the call 660 is convened within a time frame that accounts for the processing time of the agentic system 102 (e.g., a few seconds to under one minute). The agentic system 102 further dynamically spawns (e.g., creates on an as-needed basis), using computational resources 604 (e.g., resource of functional platforms 104 in FIG. 1), one or more on-call agents 652 corresponding to the collaboration 662. For example, the agentic system 102 dynamically spawns a respective on-call agent as needed using computational resources provided by the AI platform 108, the cloud platform 112, and the computing platform 114 of the functional platforms 104. The agentic system 102 further generates, by the one or more on-call agents 652, output data 632. For example, the one or more on-call agents 652 create an incident resolution report and/or a system log corresponding to the incident 630. In another example, the one or more on-call agents 652 create an operational SOP as a recommendation for further prevention and resolution procedure. The agentic system 102 further transmits the output data 632 to the user 606. For example, the output data 632 is displayed to the user 606 via a graphical UI (e.g., a UI included in the portal agentic system of the agentic system 102). The agentic system 102 further automatically terminates the one or more on-call agents 652 by releasing the computational resources 604. For example, in a scenario where the one or more on-call agents 652 are spawned to diagnose the incident 630 that defines the target issue 631 relevant to a system outage, when the target issue 631 is resolved and a system log is recorded, the one or more on-call agents 652 (e.g., the first to fifth on-call agents 552-1 to 552-5) are terminated, such that the computational resources 604 (e.g., CPUs, memory, network bandwidths, etc.) allocated to the one or more on-call agents 652 are freed up and assigned to other incident(s). In another example, in a scenario where a chatbot instance (e.g., a chatbot illustrated in FIG. 4) is created for inquiries, when interactions between the user 606 and the one or more on-call agents 652 end, the one or more on-call agents 652 (e.g., agent “KING” 450-1, agent “ANALYST” 450-2, etc.) or a subset of the one or more on-call agents 652 are terminated, such that the computational resources 604 (e.g., server memory, processing power, virtual machines, etc.) allocated to the one or more on-call agents 652 are deallocated and freed up. In yet another example, in a scenario where machine learning models for resolving incidents are trained using the one or more on-call agents 652 across graphics processing units (GPUs), when the training is completed, the one or more on-call agents 652 that are used during the training are terminated, such that GPU memory and associated processing power are freed up and reallocated to other operation(s). In some embodiments, automatically terminating the one or more on-call agents 652 (e.g., in the scenarios discussed above) corresponds to specific timing criteria. For example, the termination may occur after a predetermined period has elapsed subsequent to transmitting the output data 632 to the user 606 (e.g., further details to be discussed below). Alternatively, the termination may take place within a predetermined period and automatically cease after the predetermined period has elapsed (e.g., further details to be discussed below).

In some embodiments, the call 660 includes an incident bridge that defines the collaboration 662. The incident bridge is a communication channel for incident resolution. For example, the incident bridge facilitates a real-time coordination among humans and agents for efficient troubleshooting, decision-making, and task delegation. Specifically, the collaboration 662 is established via the incident bridge to provide seamless information exchange, role assignments, and collective problem-solving to address the target issue 631 of the incident 630. In some embodiments, the collaboration 662 is a structured and coordinated efforts that identify how to diagnose, manage, and resolve the incident 630 efficiently. For example, the collaboration 662 includes real-time communication (e.g., between humans and agents, etc.), task coordination (e.g., specific actions, patch deployment, rollback procedures, methods of assigning agents on an as-needed basis, etc.), and workflow (e.g., incident resolution workflows, response procedures, predefined escalation approaches, protocols, etc.). In some embodiments, the coordinating agent 650 is configured to interpret the incident 630 into the call 660 and coordinate agents (e.g., the one or more on-call agents 652) based on the collaboration 662. In one example, the coordinating agent 650 receives the incident 630 (e.g., a natural language query, a data query) from the user 606. The coordinating agent 650 further identifies, based on the incident 630, an intent (e.g., in forms of word embeddings). The coordinating agent 650 further creates, based on the intent, the call 660 including the collaboration 662. In another example, the coordinating agent 650 manages and orchestrates the resolution of the incident 630 via the incident bridge (e.g., the coordinating agent 650 acts as a central orchestrator within the example incident management framework 600). One primary role of the coordinating agent 650 is to ensure efficient communication, task delegation, and resource allocation among humans and agents. In some embodiments, the coordinating agent 650 monitors the status of the incident 630 and manages the computational resources 604 for dynamically spawning and/or automatically terminating the one or more on-call agents 652 on an as-needed basis to balance load and efficiency of the agentic system 102. For example, the coordinating agent 650 is configured to allocate more computational resources (e.g., CPUs, memory, storages, and network bandwidths) to the one or more on-call agents 652. In another example, the coordinating agent 650 is configured to dynamically balance and adjust the distribution of the computational resources 604 based on real-time load and system efficiency of the agentic system 102, thereby preventing performance bottlenecks in computing nodes for the one or more on-call agents 652.

In some embodiments, in response to receiving the incident 630, the agentic system 102 dynamically spawns the coordinating agent 650 using respective computational resources. For example, in response to receiving the incident 630 and within a predetermined time (e.g., a few seconds up to a few minutes), the agentic system 102 dynamically spawns the coordinating agent 650 respective computational resources (e.g., CPUs, memory, user interfaces, etc.). In particular, during the predetermined time, the agentic system 102 accesses the computational resources 604, allocates necessary resources, and prevents any conflicts in resource distribution across different incidents. In some embodiments, in accordance with a determination that the incident 630 is received by the agentic system 102, the coordinating agent 650 is dynamically spawned to execute and convene the incident 630. In this scenario, the coordinating agent 650 does not remain idle and respective computational resources (e.g., CPUs, memory, user interfaces, etc.) used for spawning the coordinating agent 650 are neither occupied and nor allocated unnecessarily. In some embodiments, the coordinating agent 650 is uniquely assigned to the incident 630 in a one-to-one correlation. In some embodiments, the coordinating agent 650 is assigned to one or more incidents including the incident 630.

In some embodiments, the collaboration 662 includes a workflow 640 having a plurality of steps 642 (e.g., step 642-1 to step 642-m, where m is an integer greater than two). The one or more on-call agents 652 includes a plurality of on-call agents (e.g., on-call agent 652-1 to on-call agent 652-n, where n is an integer greater than two). Each (e.g., first on-call agent 652-1) of the plurality of on-call agents is spawned for a respective step (e.g., first step 642-1) of the plurality of steps 642. In some embodiments, similar to the configuration illustrated in the example agentic orchestration platform 300 in FIG. 3, the workflow 640 defines, based the call 660, a process to generate the output data 632 to the user 606. In particular, the workflow 640 includes the plurality of steps 642 that define specific actions/activities for generating a target output for the user 606, such that the plurality of steps 642 are executed by the plurality of on-call agents (e.g., on-call agent 652-1 to on-call agent 652-n). In some embodiments, each of the plurality of steps 642 is assigned to (e.g., executed by) a respective on-call agent (e.g., first on-demand agent 352-1) that is distinct from remaining on-call agent(s) of the plurality of on-call agents. Stated another way, the plurality of on-call agents are distinct from each other, and each of the plurality of on-call agents (e.g., first on-call agent 652-1) is spawned for a respective step (e.g., first step 642-1) using respective computational resources. In some embodiments, one or more steps (e.g., step 642-1 and step 642-2) of the plurality of steps 642 are assigned to (e.g., executed by) the same on-call agent (e.g., first on-call agent 652-1). Stated another way, a respective on-call agent (e.g., first on-call agent 652-1) is spawned for one or more steps (e.g., step 642-1 and step 642-2) using respective computational resources.

In some embodiments, in accordance with a determination that a respective on-call agent (e.g., first on-call agent 652-1) of the plurality of on-call agents completes a respective step (e.g., step 642-1), the agentic system 102 automatically terminates the respective on-call agent to release respective computational resources used for spawning the respective on-call agent. In some embodiments, in response to detecting that a respective on-call agent (e.g., first on-call agent 652-1) of the plurality of on-call agents completes a respective step (e.g., step 642-1), the agentic system 102 automatically terminates the respective on-call agent to release respective computational resources used for spawning the respective on-call agent. For example, the agentic system 102 is configured to automatically terminate a respective on-call agent in an intermediate step (e.g., step 642-1, step 642-2, step 642-m) of the plurality of steps 642, such that the computational resources 604 are dynamically allocated on an as-needed basis (e.g., when performing operations for a SOP, when resolving an issue related to a system outage, etc.).

In some embodiments, for each of the plurality of steps 642, the agentic system 102 dynamically spawns, using respective computational resources (e.g., from computational resources 604) and by a respective on-call agent, another respective on-call agent spawned for another respective step subsequent to a respective step. Stated another way, when a respective step (e.g., first step 642-1) is assigned to a respective on-call agent (e.g., first on-call agent 652-1) and another respective step (e.g., second step 642-2) is assigned to another respective on-call agent (e.g., second on-call agent 652-2), the other respective on-call agent (e.g., second on-call agent 652-2) is dynamically spawned by the respective on-call agent (e.g., first on-call agent 652-1) using respective computational resources (e.g., from computational resources 604). For example, an on-call agent (e.g., agent “EXECUTOR”) for executing a code script can be dynamically spawned by its preceding on-call agent (e.g., agent “DEVELOPER”) for developing the code script. Specifically, in this configuration, each on-call agent is specifically spawned to handle the exact requirements for each of the plurality of steps 642, thereby improving accuracy and reducing the likelihood of errors. Additionally, by dynamically spawning on-call agents only when needed, the agentic system 102 ensures that computational resources (e.g., CPUs, memory, storages, etc.) are allocated efficiently and utilized only for the duration of each of the plurality of steps 642.

In some embodiments, for each of the plurality of steps 642, the agentic system 102 generates, by a respective on-call agent, respective data. Another on-call agent spawned for another respective step, subsequent to the respective step, is dynamically spawned based in part on the respective data. Stated another way, respective data generated by a respective on-call agent (e.g., first on-call agent 652-1) for a respective step (e.g., first step 642-1) includes information that is used by the respective on-call agent (e.g., first on-call agent 652-1) to dynamically spawn a subsequent on-call agent (e.g., second on-call agent 652-2) for a subsequent step (e.g., second step 642-2). For example, the respective data generated by the respective on-call agent includes a set of system logs along with an information indicative that a summary of the system logs needs to be created. Accordingly, the respective on-call agent dynamically spawns a subsequent on-call agent (e.g., agent “SUMMARIZER”) to summarize the system logs. In another example, when the respective data generated by the respective on-call agent includes a code script, the respective on-call agent determines, based on the code script, that a follow-up execution is required, and further dynamically spawns a subsequent on-call agent (e.g., agent “EXECUTOR”) to execute the code script.

In some embodiments, when a respective step is an initial step (e.g., first step 642-1) of the plurality of steps 642, a respective on-call agent spawned for the respective step is dynamically spawned by the coordinating agent 650. For example, in some embodiments, in response to convening the call 660, the coordinating agent 650 dynamically spawns the first on-call agent 652-1 to initiate the workflow 640. In this scenario, the first on-call agent 652-1 does not remain idle and respective computational resources (e.g., CPUs, memory, user interfaces, etc.) for spawning the first on-call agent 652-1 are neither occupied and nor allocated unnecessarily prior to the call 660 being convened by the coordinating agent 650.

In some embodiments, for each of the plurality of steps 642, in accordance with a determination that a respective step requires an execution of a code script, the agentic system 102 temporarily suspends the respective step. The agentic system 102 further sends, by a respective on-call agent, an authorization request 670 to the user 606. In accordance with a determination that a user authorization 672 is received, the agentic system 102 resumes, by the respective on-call agent, the respective step. For example, in accordance with a determination that a respective step requires an execution of a code script by an agent “EXECUTOR,” the agentic system 102 temporarily suspends the execution. Subsequently or concurrently, the agentic system 102 seeks a permission from the user 606 by sending the authorization request 670. In response to receiving the authorization request 670, the user 606 reviews the code script and corresponding information (e.g., severity/priority level of the incident 630, scope of the code script), the user 606 creates the user authorization 672 for the agent “EXECUTOR” to execute the code script. In some circumstances, the user authorization 672 includes a different instruction (e.g., changing line codes, running only a specific portion of the code script). In some embodiments, a respective on-call agent cannot execute a code script independently (e.g., when executing the code script alters the state of a system). For example, when executing a code script impacts system configurations, modifies critical data, or triggers automated processes with significant consequences, the respective on-call agent is restricted from proceeding autonomously. In this situation, the agentic system 102 suspends the execution of the code script until a permission/authorization is received from user 606. In some embodiments, the user authorization 672 includes clarifications (e.g., adjustments/refinements to the code script) and/or instructions (e.g., running only a specific portion of the code script) from the user 606. In some embodiments, the user authorization 672 includes customized instructions (e.g., conditional execution corresponding to the severity/priority level of the incident 630, time-based execution corresponding to a predetermined timeframe, role-based execution corresponding to access to restricted data/database). In some embodiments, the user authorization 672 is part of user supervision (e.g., supervision 134 in FIG. 1, user supervision 334 in FIG. 3).

In some embodiments, automatically terminating the one or more on-call agents 652 is performed in response to sending the output data 632 to the user 606. For example, in a scenario where the one or more on-call agents 652 are assigned to analyze historical system logs for errors, in response to sending an error report to the user 606, the agentic system 102 automatically shuts down and terminates the one or more on-call agents 652 to free up associated computational resources. In particular, the agentic system 102 automatically terminates the one or more on-call agents 652 without intentionally introducing a delay in time. In another example, in a scenario where the one or more on-call agents 652 are assigned to extract historical incidents for generating a SOP, in response to sending the SOP to the user 606, the agentic system 102 automatically shuts down and terminates the one or more on-call agents 652 to release associated computational resources.

In some embodiments, automatically terminating the one or more on-call agents 652 is performed after a predetermined period elapses subsequent to transmitting the output data 632 to the user 606. Specifically, this configuration allows for a grace period before the agentic system 102 terminates the one or more on-call agents 652, thereby ensuring the flexibility for the user 606 to provide supervision while optimizing computational resource usage. For example, in a scenario where the one or more on-call agents 652 are assigned to resolve a system outage, in response to sending a resolution recommendation to the user 606, the agentic system 102 instructs the one or more on-call agents 652 to remain active or idle for a predetermined period (e.g., one hour) to accommodate new system outage incident(s) received from the user 606. In accordance with a determination that no new incident is received within one hour, the agentic system 102 automatically shuts down and terminates the one or more on-call agents 652 to release associated computational resources. In another example, in a scenario where the one or more on-call agents 652 are assigned to generate and execute a code script (e.g., a maintenance script), in response to running the code script and sending a corresponding outcome to the user 606, the agentic system 102 instructs the one or more on-call agents 652 to remain active or idle for a predetermined period (e.g., 10 minutes) to accommodate a need from the user 606 to rerun the code script or review execution logs. In accordance with a determination that no additional supervision (e.g., request to rerun the code script, request to review execution logs) is received from the user 606, the agentic system 102 automatically shuts down and terminates the one or more on-call agents 652 to release associated computational resources.

In some embodiments, automatically terminating the one or more on-call agents 652 is performed within a predetermined period and automatically ceases after the predetermined period elapses. Specifically, this configuration provides a controllable and tunable termination window to maintain operational efficiency and flexibility for the agentic system 102. For example, the agentic system 102 is configured to periodically (e.g., every 30 minutes) detect idle on-call agent(s) and initiate a termination process that runs for a predetermined period (e.g., 10 minutes) for terminating the detected idle on-call agent(s). Once the predetermined period expires, the termination process ceases until the next scheduled check. In another example, the agentic system 102 is configured to periodically (e.g., every 24 hours) optimize computational resources by terminating idle on-call agent(s). A termination cycle runs for a predetermined period (e.g., one hour) to free up computational resources. After the predetermined period, no additional idle on-call agent(s) are terminated until the next scheduled optimization cycle.

In some embodiments, the incident 630 includes a severity level (e.g., high-severity “S1,” medium-severity “S2,” low-severity “S3,” etc.) and/or a priority level (e.g., critical-priority “P1,” high-priority “P2,” medium-priority “P3,” low-priority “P4,” etc.). The call 660 is convened based in part on the severity level and/or the priority level. In particular, the coordinating agent 650, based on the severity level and/or the priority level, dynamically allocates and optimizes the distribution of the computational resources 604, thereby ensuring efficient resource management and workload balancing for the incident 630. For example, in accordance with a determination that the incident 630 includes a high-severity level “S1” and a critical-priority level “P1” outage (e.g., a system/service outage), the coordinating agent 650 prioritizes respective computation resources (e.g., CPUs, memory, storages, computing nodes, etc.) for the call 660 and temporarily suspends non-essential background incidents/tasks. In another example, in accordance with a determination that the incident 630 includes a low-severity level “S3” and a medium-priority level “P3” event (e.g., an application malfunction, a request to summarize system logs), the coordinating agent 650 deprioritizes respective computation resources (e.g., CPUs, memory, storages, computing nodes, etc.) for the call 660 and initiates the workflow 640 during non-peak hours.

In some embodiments, the computational resources 604 includes at least one of the group consisting of (i) computing resources (e.g., CPUs, GPUs, server loads, etc.), (ii) memory resources (in-memory caching, virtual machines, etc.), and (iii) cloud resources (e.g., cloud storages, network bandwidths, etc.). In some embodiments, the computational resources 604 is part of the plurality of functional platforms 104 in FIG. 1 including the user platform 106, the AI platform 108, the database platform 110, the cloud platform 112, the computing platform 114, the device platform 116, the documentation platform 118, and the UI platform.

In some embodiments, the example incident management framework 600 incorporates user supervision, similar to the example agentic orchestration platform 300 in FIG. 3 and the example incident management framework 510 in FIG. 5B. In particular, the agentic system 102 receives user supervision 634 (e.g., similar to supervision 134 in FIG. 1, user supervision 334 in FIG. 3, and first and second user supervisions 534-1 and 534-2 in FIG. 5B) associated with the output data 632. The agentic system 102 further determines, based on the user supervision 634 and by a respective agent of the coordinating agent 650 and the one or more on-call agents 652, whether the output data 632 requires updating. In accordance with a determination that the output data 632 requires updating, the agentic system 102 further updates the output data 632 to form updated output data 632′. The agentic system 102 further transmit the updated output data 632′ to the user 606. In some embodiments, the user supervision 634 includes a two-fold supervision: (i) the user 606 reviews and provides clarifications (e.g., adjustments/refinements to output data 632) and (ii) the user 606 reviews and provides authorization (e.g., a permission for executing a respective step by a respective on-call agent).

In some embodiments, each agent of the coordinating agent 650 and the one or more on-call agents 652 is driven by a respective computational component from a plurality of computational components (e.g., data analytics, analytical models, machine-learning models, LLMs, plugins, other types of models, or a combination of various types). In some embodiments, the plurality of computational components are built using a combination of resources received from and/or stored in the plurality of functional platforms 104 (e.g., the user platform 106, the AI platform 108, the database platform 110, the cloud platform 112, the computing platform 114, the device platform 116, the documentation platform 118, and/or the UI platform 120). In some embodiments, the plurality of computational components include at least one of the group consisting of (i) an analytical model (e.g., regression model, decision tree, clustering, etc.), (ii) an LLM (e.g., deep learning models, natural language processing, etc.), and (iii) a plugin (e.g., query plugin, automation plugin, chatbot plugin, knowledge base integration, etc.).

In some embodiments, the operations (e.g., receiving the incident 630, transmitting the output data 632 and the updated output data 632′ to the user 606) in the example incident management framework 600 are performed in a graphical portal (e.g., incident dashboard, incident ticketing system, collaboration panel, reporting graphical tool, etc.). In some embodiments, the graphical portal associated with the example incident management framework 600 is part of the portal agentic system of the agentic system 102. In some embodiments, the graphical portal associated with the example incident management framework 600 is similar to the example UI 400 in FIG. 4.

### WebUI Self-Service Interface and Use Cases

In some embodiments, the agentic system 102 is configured to drive various use cases, including but not limited to (i) inventory and configuration audit (e.g., automating audit processes to save time and reduce errors), (ii) error analysis and resolution (e.g., rapidly identifying and resolving errors, minimizing downtime), (iii) log summarization and prioritization (e.g., extracting critical information from logs and prioritizing alerts), (iv) SOP creation (e.g., automating creation of SOPs), (v) content validation, correction, and translation (e.g., streamlining content-related tasks), (vi) workflow a optimization (e.g., identifying and implementing improvements in existing workflows), (vii) operational readiness review (ORR) and checkpoint management (e.g., automating onboarding applications and creation of new checkpoints), (viii) global business services (GBS) onboarding (e.g., automating steps for onboarding business unit applications supported by GBS (e.g., cloud management services (CMS), infrastructure portfolio management (IPM), IT service management (ITSM), etc.)), (ix) AI-powered business process automation (BPA) (e.g., leveraging agents to offset manual and/or mundane business processes), (xi) scale-out teams (e.g., augmenting teams with agents to increase team sizes), and (xii) respective mean time to repair (MTTR) reduction (e.g., automating diagnostics, providing real-time recommendations, and/or executing predefined remediation steps).

In some embodiments, the agentic system 102 is configured to reduce MTTR for incidents by proactively searching for critical incidents. In particular, the agentic system 102 proactively search for critical incidents, which are collected and stored in a database (e.g., a database of the database platform 110 in FIG. 1), and generated simplified, standardized resolutions. This process enables the agentic system 102 to retrieve the simplified, standardized resolutions directly in a shorter timeframe when resolving new critical incidents. An outcome of this process is to provide a library of simplified, standardized SOPs that are available to rapidly resolve any new critical incidents, and each simplified, standardized SOP is leveraged across IT services at scale for the same/similar critical incident. For example, the agentic system 102 generates a simplified, standardized SOP based on a total of 83 SOPs (e.g., 13 SOPs resolve respective incidents, 5 SOPs require further investigation, 65 SOPs are pending for further validation) within a total time of 1.3 mins, which provides a time saving of approximately 3.5 hours in average for each human. Without the agentic system 102, a process of generating a simplified, standardized SOP for these 83 SOPs may require an average of 290 hours (e.g., at least 2 hours on average for researching critical incidents, identifying issues, co-relating issues to respective root causes requires; at least 1.5 hours on average for documenting an SOP and detecting errors).

Specifically, in some embodiments, a user request (e.g., the user request 330 and/or the incident 530) defines a request to reduce a respective MTTR for an incident stored in a first database (e.g., a database of the database platform 110 in FIG. 1). The agentic system 102 generates, based on the user request and by an agent (e.g., the first agent 350-1, the first on-call agent 552-1), a workflow (e.g., the workflow 140 in FIG. 3 and/or the second pipeline 512 in FIG. 5B) that includes a respective step having a respective task for searching the incident in the first database. The agentic system 102 further process the workflow by one or more agents (e.g., the one or more on-demand agents 352, the plurality of on-call agents 552) to generate output data including a respective SOP configured to reduce the respective MTTR for the incident. For example, the agentic system 102 generates by agent(s) integrated log analytics that are used to retrieve all critical incidents. In another example, the agentic system 102 generates by agent(s) a standardized, detailed SOP for each critical incident.

In some embodiments, the agentic system 102 is configured to reduce MTTR for incidents by generating automation scripts for SOPs stored in a database (e.g., a database of the database platform 110 in FIG. 1). An outcome of this process is to provide a library of reusable scripts derived from the SOPs that can be deployed in various IT service environments, and each automation script is leveraged across IT services at scale for the same/similar critical incident. For example, the agentic system 102 generates 83 scripts based on a total of 83 SOPs, where generation of each script is accomplished within a total time of 59 secs, which provides a time saving of approximately 10-20 hours for a human (e.g., with respect to time for peer review, script validation, etc.). Without the agentic system 102, a process of generating these 83 scripts may require an average 2,490 hours (e.g., time for researching critical incidents, identifying automation plans, creating and researching automation scripts; time for drafting and developing automation scripts using best practices; time for validating scripts for errors (e.g., peer review) and ensuring scripts are written using the latest supported framework for respective operating system(s) and critical incidents).

Specifically, in some embodiments, a user request (e.g., the user request 330 and/or the incident 530) defines a user request (e.g., the user request 330 and/or the incident 530) defines a request to reduce a respective MTTR for a plurality of SOPs stored in a second database (e.g., a database of the database platform 110 in FIG. 1). The agentic system 102 generates, based on the user request and by an agent (e.g., the first agent 350-1, the first on-call agent 552-1), a workflow (e.g., the workflow 140 in FIG. 3 and/or the second pipeline 512 in FIG. 5B) that includes a respective step having a respective task for receiving the plurality of SOPs from the second database. The agentic system 102 further process the workflow by one or more agents (e.g., the one or more on-demand agents 352, the plurality of on-call agents 552) to generate output data including a script with a set of code statements configured to reduce the respective MTTR for the plurality of SOPs. For example, the agentic system 102 leverages LLMs through agent(s) to generate the script that adhere to coding best practices. In another example, the agentic system 102 drives agent(s) to review the script for errors and validation.

FIG. 7 illustrates an example self-service framework 700 that implements the agentic system 102, in accordance with some embodiments. In particular, the example self-service framework 700 is configured as a webUI-based self-service platform that facilitates communications between users and the agentic system 102. In some embodiments, the example self-service framework 700 drives use cases as discussed above (e.g., MTTR reduction, log summarization and prioritization, SOP creation, etc.). In some embodiments, the example self-service framework 700 is operated based on the WebUI agentic system (e.g., one of the modalities of the agentic system 102). In some embodiments, the example self-service framework 700 is similar to the example incident management framework 510 and the example incident management framework 600, all of which are AI-augmented and built based on the agentic system 102. In some embodiments, on-call agents and on-demand agents are exchangeable.

In some embodiments, as shown in FIG. 7, the agentic system 102 receives, by an interface agent 750-1 and via a webUI 702, a first user query 730-1 from a user 706 that defines a request to summarize historical data 712 corresponding to a critical event 710 associated with a plurality of incidents 714 (e.g., e.g., incident 714-1 to incident 714-k, where k is an integer greater than two). For example, in a scenario where the user 706 intends to review a history of incidents related to critical event 710 in domain secure session setup, the user 706 sends the first user query 730-1 via the webUI 702 that defines a request to retrieve historical incident reports associated with the domain secure session setup, identify recurring patterns, and provide a summary of root causes, resolutions, and impact. In another example, in a scenario where the user 706 intends to review a history of incidents related to critical event 710 associated with email false alerts, the user 706 sends the first user query 730-1 via the webUI 702 that defines a request to retrieve historical data on reported errors/incidents and provide a summary of affected accounts and corrective measures that were implemented. In response to receiving the first user query 730-1, the agentic system 102 further generates, by an executing agent 750-2, an event report 732 associated with the critical event 710. For example, in some embodiments, the event report 732 includes a summary of historical data 712 of the incidents 714 (e.g., incident 714-1 to incident 714-k) having incident logs (e.g., resolution history, root cause analysis, reviews, alerts, error messages, etc.). The agentic system 102 further displays, by the interface agent 750-1 and via the webUI 702, the event report 732 to the user 706. For example, the event report 732 is displayed via the webUI 702 in various formats, including but not limited to texts, tables, files, slides, and other supported formats. The agentic system 102 further receives, by the interface agent 750-1 and via the webUI 702, a second user query 730-2 from the user 706 that defines a request to reduce a MTTR for resolving the critical event 710. For example, after the user 706 reviews the event report 732 associated with the domain secure session setup, the user 706 sends the second user query 730-2 via the webUI 702 that defines a request to reduce a MTTR for resolving errors occurred during the domain secure session setup. In another example, after the user 706 reviews the event report 732 associated with the email false alerts, the user 706 sends the second user query 730-2 via the webUI 702 that defines a request to reduce a MTTR for resolving tickets related to the email false alerts. In response to receiving the second user query 730-2, the agentic system 102 further generates, by the executing agent 750-2, an enhanced SOP 738 configured to reduce the MTTR for resolving the critical event 710. In particular, the enhanced SOP 738 is a refined and comprehensive SOP associated with the critical event 710. For example, the enhanced SOP 738 standardizes existing SOPs to include integrated steps, predefined escalation paths, and pre-allocated resources. In another example, the enhanced SOP 738 includes automation, such as automated feedback loops and follow-ups, automated data collections, and real-time monitoring and collaborations. The agentic system 102 further displays, by the interface agent 750-1 and via the webUI 702, the enhanced SOP 738 to the user 706. For example, the enhanced SOP 738 is displayed via the webUI 702 in various formats, including but not limited to texts, tables, files, slides, and other supported formats (e.g., code scripts).

In some embodiments, the webUI 702 (e.g., example webUI 800 in FIGS. 8A-8E) serves as a visual and interactive application/website for the user 706 to interact with the agentic system 102 (e.g., through a web browser). In particular, the webUI 702 enhances self-service experiences by providing an efficient platform (e.g., featuring AI augmented experiences, task-specialized interfaces, 24/7 accessibility, etc.) for the user 706 to send user queries and obtain results from the agentic system 102. In some embodiments, the interface agent 750-1 (e.g., similar to first agent 350-1 in FIG. 3) is built using computational resources from the plurality of functional platforms 104 and configured to interact with the user 706 and navigate the webUI 702. Moreover, the interface agent 750-1 is configured to communicate with other agents (e.g., executing agent 750-2, other on-demand/on-call agents) of the agentic system 102. In some embodiments, the executing agent 750-2 (e.g., similar to second agent 350-2 in FIG. 3 and coordinating agent 650 in FIG. 6) is built using computational resources from the plurality of functional platforms 104 and configured to execute tasks and actions (e.g., workflow automation, real-time computation and analysis, system incident/error discovery, etc.) corresponding to user queries from the user 706. Moreover, the executing agent 750-2 functions as a backend executor and does not interact directly with the user 706. In some embodiments, the executing agent 750-2 includes a coordinating agent (e.g., similar to coordinating agent 650 in FIG. 6) and one or more on-call agents (e.g., similar to one or more on-call agents 652). In particular, the one or more on-call agents are dynamically spawned by the coordinating agent (e.g., similar to the dynamic spawning configuration in reference to FIG. 6).

In some embodiments, the historical data 712 includes a plurality of SOPs 716 (e.g., SOP 716-1 to SOP 716-k, where k is an integer greater than two). Each (e.g., SOP 716-1) of the plurality of SOPs 716 is associated with a corresponding incident (e.g., incident 714-1) of the plurality of incidents 714. For example, during the occurrence of each incident associated with the critical event 710, a corresponding SOP is created (e.g., by a user) to document necessary procedures and steps. In some circumstances, the corresponding SOP functions as a temporary resolution and may not be sufficiently precise or comprehensive. In other circumstances, the corresponding SOP (e.g., SOP 716-1) associated with an incident (e.g., incident 714-1) is a direct or closely replicated copy of another SOP (e.g., SOP 716-k) associated with another incident (e.g., incident 716-k).

In some embodiments, the historical data 712 includes a plurality of incident logs 718 (e.g., incident log 718-1 to incident log 718-k, where k is an integer greater than two). Each (e.g., incident log 718-1) of the plurality of incident logs 718 is associated with a corresponding incident (e.g., incident 714-1) of the plurality of incidents 714 and has a corresponding resolution history. For example, in some embodiments, a respective incident log includes resolution history (e.g., resolution steps, temporary solutions, rollback actions, etc.), root cause analysis (e.g., cause identifications, contributing factors, mitigation strategies, etc.), reviews (e.g., internal/external feedback, summaries, etc.), alerts (e.g., system alerts, escalations, notifications, etc.), error messages (e.g., error codes, pop-ups, failure reports, etc.), and other aspects (e.g., severity/priority levels, resource usages, time to resolve, etc.). In particular, the plurality of incident logs 718 are summarized by the executing agent 750-2 and presented to the user 706 as part of the event report 732.

In some embodiments, in response to receiving the first user query 730-1, the agentic system 102 transmits, by the interface agent 750-1, the first user query 730-1 to the executing agent 750-2. The agentic system 102 further retrieves, by the executing agent 750-2 and based on the first user query 730-1, the historical data 712 from a repository database 704. The agentic system 102 further generates, by the executing agent 750-2, the event report 732 to summarize the historical data 712. The agentic system 102 further sends, by the executing agent 750-2, the event report 732 to the interface agent 750-1. In some embodiments, the repository database 704 stores and archives records of the plurality of incident logs 718. For example, the repository database 704 includes a schema to enable efficient data retrieval and query performance. In another example, the repository database 704 includes a metadata database that archives metadata of the historical data 712 associated with the critical event 710. In some embodiments, the repository database 704 stores and archives records of incidents corresponding to one or more critical events associated with the agentic system 102. In some embodiments, the repository database 704 is part of the plurality of functional platforms 104 in FIG. 1 (e.g., database platform 110).

In some embodiments, in response to receiving the second user query 730-2, the agentic system 102 transmits, by the interface agent 750-1, the second user query 730-2 to the executing agent 750-2. The agentic system 102 further analyzes, by the executing agent 750-2 and based on the second user query 730-2, the historical data 712 to generate the enhanced SOP 738 configured to reduce the MTTR for resolving the critical event 710. The agentic system 102 further sends, by the executing agent 750-2, the enhanced SOP 738 to the interface agent 750-1. For example, in an IT server outage scenario, the executing agent 750-2 analyzes the historical data 712 (e.g., historical incident logs, previous resolution steps) to generate the enhanced SOP 738 that includes predefined reboot procedures and automated system diagnostics to minimize the MTTR (e.g., a system downtime). In another example, in a false alert scenario, the executing agent 750-2 analyzes the historical data 712 (e.g., historical false alerts, previous mitigation steps) to generate the enhanced SOP 738 that includes refined detection procedures and automated system diagnostics to minimize the MTTR (e.g., a response time).

In some embodiments, the enhanced SOP 738 includes a code script 740 configured to generate a textual SOP corresponding to the enhanced SOP 738. When the agentic system 102 analyzes the historical data 712, the agentic system 102 validates, by the executing agent 750-2, the code script 740 to minimize errors. For example, the agentic system 102 leverages LLMs through the executing agent 750-2 to generate the code script 740 that automatically generates a textual SOP to the user 706. In another example, the agentic system 102 drives the executing agent 750-2 to review and validate the code script 740 for errors and validation. In some embodiments, validation of the code script 740 requires a user supervision (e.g., similar to supervision 134 in FIG. 1, user supervision 334 in FIG. 3, first and second user supervisions 534-1 and 534-2 in FIG. 5B, and user supervision 634 in FIG. 6).

In some embodiments, each agent of the interface agent 750-1 and the executing agent 750-2 is driven by a respective computational component from a plurality of computational components (e.g., data analytics, analytical models, machine-learning models, LLMs, plugins, other types of models, or a combination of various types). In some embodiments, the plurality of computational components are built using a combination of resources received from and/or stored in the plurality of functional platforms 104 (e.g., the user platform 106, the AI platform 108, the database platform 110, the cloud platform 112, the computing platform 114, the device platform 116, the documentation platform 118, and/or the UI platform 120). In some embodiments, the plurality of computational components include at least one of the group consisting of (i) an analytical model (e.g., regression model, decision tree, clustering, etc.), (ii) an LLM (e.g., deep learning models, natural language processing, etc.), and (iii) a plugin (e.g., query plugin, automation plugin, chatbot plugin, knowledge base integration, etc.).

FIGS. 8A-8E illustrate an example webUI 800 of the agentic system 102, in accordance with some embodiments. In particular, the example webUI 800 is configured to facilitate the functionality of the webUI 702 of the example self-service framework 700. In some embodiments, the example webUI 800 is configured as a webUI-based self-service platform that facilitates communications between users and the agentic system 102. In some embodiments, the example webUI 800 drives user-system interactions for use cases as discussed above (e.g., MTTR reduction, log summarization and prioritization, SOP creation, etc.). In some embodiments, the example webUI 800 is operated based on the WebUI agentic system (e.g., one of the modalities of the agentic system 102).

FIG. 8A illustrates a screenshot 801 of a main user interface of the example webUI 800. In particular, the screenshot 801 includes a history pane 810 and a home pane 820 displayed concurrently. The history pane 810 displays chat history (e.g., recent chats). The home pane 820 displays a plurality of user query examples 822 and includes an input tab 824 configured to receive user queries (e.g., first user query 730-1 and second user query 730-2 in FIG. 7).

FIG. 8B illustrates a screenshot 802 of the home pane 820 of the example webUI 800 displaying a user query 826 from a user and an event report 828 generated by the agentic system 102 corresponding to the user query 826. In particular, the user query 826 defines a request to summarize historical data corresponding to an event associated with a plurality of incidents (e.g., “list insights about incidents relating to hCue application”). In response to receiving the user query 826, the agentic system 102 further generates (e.g., by one or more agents), the event report 828 associated with the event (e.g., “hCue application”). As shown in FIG. 8B, the event report 828 includes incident description, incident start time, resolution, root cause, solution proposal, problem number, problem stage, additional incident, resolution time, and final root cause. In some embodiments, the information provided in the event report 828 is obtained from incident log(s) (e.g., plurality of incident logs 718 in FIG. 7) associated with the event (e.g., “hCue application”).

FIG. 8C illustrates another screenshot 803 of the home pane 820 of the example webUI 800 displaying a user query 830 from a user and an event report 832 generated by the agentic system 102 corresponding to the user query 830. In particular, the user query 830 defines a request to summarize historical data corresponding to an event associated with a plurality of incidents (e.g., “list incidents in 2024”). In response to receiving the user query 830, the agentic system 102 further generates (e.g., by one or more agents), the event report 832 associated with the event (e.g., timeframe of “2024”). As shown in FIG. 8C, the event report 832 includeds a short summary of a total of 403 incidents, a brief description of three highlighted incidents (e.g., “INC2646633,” “INC2647482,” and “INC2650314”), and an option 834 to download the results associated with these 403 incidents. In some embodiments, the information provided in the event report 832 is obtained from incident log(s) (e.g., plurality of incident logs 718 in FIG. 7) associated with the event (e.g., timeframe of “2024”).

FIG. 8D illustrates another screenshot 804 of the home pane 820 of the example webUI 800 displaying an event report 836 generated by the agentic system 102 corresponding to a user query. Similarly, the event report 836 includes three highlighted incidents and an option 838 to download the results associated with a total of 361 incidents. In some embodiments, the information provided in the event report 836 is obtained from incident log(s) (e.g., plurality of incident logs 718 in FIG. 7).

FIG. 8E illustrates a screenshot 805 of the result pane 850 of the example webUI 800 displaying query results (e.g., as part of the event report 836) generated by the agentic system 102 corresponding to a user query. In some embodiments, the result pane 850 is displayed concurrently with the home pane 820 and/or the history pane 810. The result pane 850 displays a summary table 852 corresponding to the query results. The summary table 852 includes a “number” column 854 (e.g., serial numbers of incidents), a “created_at” column 856 (e.g., time when incidents were created by a human or an agent), a “description column 858 (e.g., a brief summary of each incident), and a “priority” column 860 (e.g., priority levels such as “critical” and “high”). In some embodiments, the information provided in the result pane 850 is obtained from incident log(s) (e.g., plurality of incident logs 718 in FIG. 7).

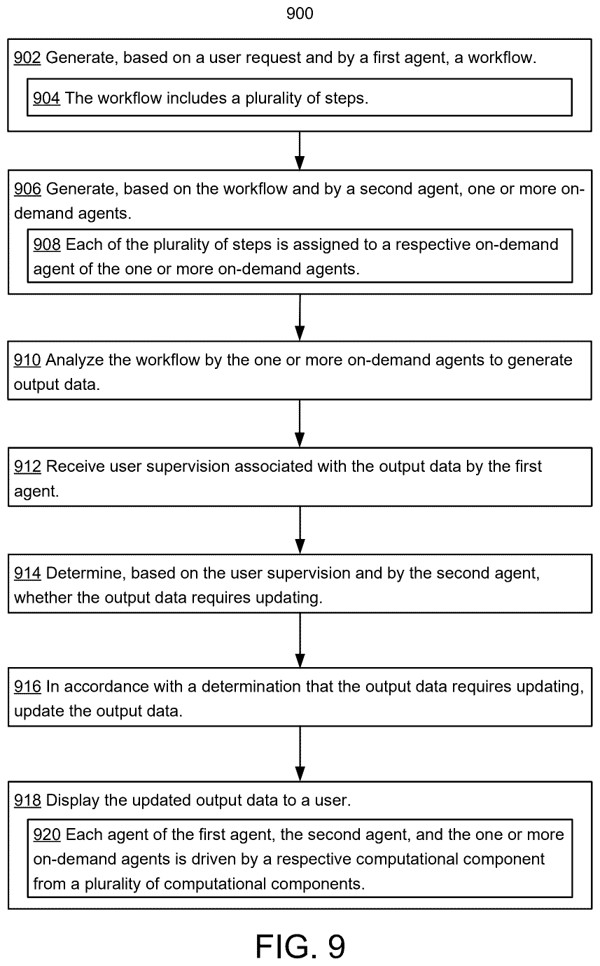

FIG. 9 is a flow diagram illustrating a method 900 of orchestrating agents for a user task, in accordance with some embodiments. The method 900 may be performed at a computer system (e.g., the computer system 200, FIG. 2) having one or more processors and memory storing instructions for execution by the one or more processors. In some embodiments, the method 900 is performed by executing instructions stored in memory (e.g., memory 210, FIG. 2) of the computer system.

In some embodiments, each of the agents described below is an artificial intelligence agent. In some embodiments, each of the agents described below includes an LLM. In some embodiments, each of the events described below is a critical event (e.g., associated with critical and high-priority incidents) and requires computation (e.g., real-time user/incident data analysis, code script generations, resource-intensive computations/inquiries, etc.).
(A1-a) The method 900 includes generating (operation 902), based on a user request 330 and by a first agent 350-1, a workflow 140. The workflow 140 includes (operation 904) a plurality of steps 342. The method 900 further includes generating (operation 906), based on the workflow 140 and by a second agent 350-2, one or more on-demand agents 352. Each of the plurality of steps 342 is assigned (operation 908) to a respective on-demand agent (e.g., a first on-demand agent 352-1) of the one or more on-demand agents 352. The method 900 further includes analyzing (operation 910) the workflow 140 by the one or more on-demand agents 352 to generate output data 332. The method 900 further includes receiving (operation 912) user supervision 334 associated with the output data 332 by the first agent 350-1. The method 900 further includes determining (operation 914), based on the user supervision 334 and by the second agent 350-2, whether the output data 332 requires updating. The method 900 further includes in accordance with a determination that the output data 332 requires updating, updating (operation 916) the output data 332. The method 900 further includes displaying (operation 918) the updated output data 332′ to a user 306. Each agent of the first agent 350-1, the second agent 350-1, and the one or more on-demand agents 352 is driven (operation 920) by a respective computational component from a plurality of computational components.
(A1-b) In some embodiments, the method 900 includes instantiating (e.g., generating), based on a request (e.g., user request 330) from a user 106 and by an external interface artificial intelligence agent (e.g., first agent 350-1), a workflow 140. The workflow 140 includes a plurality of steps 342 configured to resolve a critical computing event. The method 900 further includes instantiating (e.g., generating), based on the workflow 140 and by an internal orchestrating artificial intelligence agent (e.g., second agent 350-2), one or more on-demand artificial intelligence agents (e.g., one or more on-demand agents 352). The method 900 further includes executing the workflow 140 by the one or more on-demand artificial intelligence agents (e.g., one or more on-demand agents 352) to generate output data 332 for the internal orchestrating artificial intelligence agent (e.g., second agent 350-2). Executing the workflow 140 includes, for each of the plurality of steps 342: assigning a respective step (e.g., first step 642-1) to a respective on-demand artificial intelligence agent (e.g., a first on-demand agent 352-1) of the one or more on-demand artificial intelligence agents (e.g., one or more on-demand agents 352); and executing, by the respective on-demand artificial intelligence agent (e.g., a first on-demand agent 352-1), the respective step (e.g., first step 642-1) to generate respective data (e.g., respective data 362-1). The method 900 further includes transmitting, by the internal orchestrating artificial intelligence agent (e.g., second agent 350-2), the output data 332 to the external interface artificial intelligence agent (e.g., first agent 350-1). The method 900 further includes displaying, by the external interface artificial intelligence agent (e.g., first agent 350-1), the output data 332 to the user 106. The method 900 further includes receiving user supervision 334 corresponding to the critical computing event and the output data 332. The method 900 further includes transmitting, by the external interface artificial intelligence agent (e.g., first agent 350-1), the user supervision 334 to the internal orchestrating artificial intelligence agent (e.g., second agent 350-2). The method 900 further includes determining, based on the user supervision 334 and by the internal orchestrating artificial intelligence agent (e.g., second agent 350-2), whether the output data 332 requires updating. The method 900 further includes in accordance with a determination that the output data 332 requires updating, updating, by the one or more on-demand artificial intelligence agents (e.g., one or more on-demand agents 352), the output data 332 to generate updated output data 332′ for the internal orchestrating artificial intelligence agent (e.g., second agent 350-2). The method 900 further includes transmitting, by the internal orchestrating artificial intelligence agent (e.g., second agent 350-2), the updated output data 332′ to the external interface artificial intelligence agent (e.g., first agent 350-1). The method 900 further includes displaying, by the external interface artificial intelligence agent (e.g., first agent 350-1), the updated output data 332′ to the user 106. Each artificial intelligence agent of the external interface artificial intelligence agent (e.g., first agent 350-1), the internal orchestrating artificial intelligence agent (e.g., second agent 350-2), and the one or more on-demand artificial intelligence agents (e.g., one or more on-demand agents 352) is distinct from every other artificial intelligence agent and includes a large-language model.
(A2-a) In some embodiments of A1-a, the first agent 350-1 is configured to communicate data with the user 306 and the second agent 350-2. The second agent 350-2 is configured to communicate data with the first agent 350-1 and supervise the one or more on-demand agents 352 based on the workflow 140.
(A2-b) In some embodiments of A1-b, the external interface artificial intelligence agent (e.g., first agent 350-1) is configured to communicate data with the user 106 and the internal orchestrating artificial intelligence agent (e.g., second agent 350-2). The internal orchestrating artificial intelligence agent (e.g., second agent 350-2) is configured to communicate data with the external interface artificial intelligence agent (e.g., first agent 350-1) and orchestrate the one or more on-demand artificial intelligence agents (e.g., one or more on-demand agents 352) based on the workflow 140.
(A3-a) In some embodiments of A1-a to A2-a, generating the workflow 140 includes receiving a user query associated with the user request 330 from the user 306, identifying, based on the user query, a user intent, and creating, based on the user intent, the workflow 140.
(A3-b) In some embodiments of A1-b to A2-b, instantiating (e.g., generating) the workflow 140 includes receiving a user query associated with the request (e.g., user request 330) from the user 106, identifying, based on the user query, a user intent, and creating, based on the user intent, the workflow 140.
(A4-a) In some embodiments of A1-a to A3-a, each of the plurality of steps 342 includes a respective task message identifying a respective task. Generating the one or more on-demand agents 352 includes for each of the plurality of steps 342: analyzing the respective task message, and identifying, based on the analyzed respective task message, the respective on-demand agent.
(A4-b) In some embodiments of A1-b to A3-b, each of the plurality of steps 342 includes a respective task message identifying a respective task. Instantiating (e.g., generating) the one or more on-demand artificial intelligence agents (e.g., one or more on-demand agents 352) includes: for each of the plurality of step 342s: analyzing the respective task message; and identifying, based on the analyzed respective task message, the respective on-demand artificial intelligence agent.
(A5-a) In some embodiments of A1-a to A4-a, a respective on-demand agent (e.g., a second on-demand agent 352-2) of the one or more on-demand agents 352 is dynamically created by another respective on-demand agent (e.g., a first on-demand agent 352-1) of the one or more on-demand agents 352.
(A5-b) In some embodiments of A1-b to A4-b, a respective on-demand artificial intelligence agent (e.g., a second on-demand agent 352-2) of the one or more on-demand artificial intelligence agents (e.g., one or more on-demand agents 352) is dynamically created by another respective on-demand artificial intelligence agent (e.g., a first on-demand agent 352-1) of the one or more on-demand artificial intelligence agents (e.g., one or more on-demand agents 352).
(A6-a) In some embodiments of A1-a to A5-a, analyzing the workflow 140 includes: for each of the plurality of steps 342, processing the respective task by the respective on-demand agent (e.g., a first on-demand agent 352-1) to generate respective data (e.g., respective data 362-1); and generating, based on the respective data and by the second agent 350-2, the output data 332.
(A6-b) In some embodiments of A1-b to A5-b, executing the workflow 140 includes: for each of the plurality of steps 342: executing, by the respective on-demand artificial intelligence agent (e.g., a first on-demand agent 352-1), the respective task to generate the respective data (e.g., respective data 362-1) for another respective on-demand artificial intelligence agent (e.g., a second on-demand agent 352-2) that processes another respective task subsequent to the respective task; and generating, based on the respective data from a corresponding on-demand artificial intelligence agent (e.g., a last on-demand agent 352-n) that is assigned to a last step agent (e.g., a last step 352-m) of the plurality of steps 342, the output data 332.
(A7-a) In some embodiments of A1-a to A6-a, the respective data (e.g., respective data 362-1) includes a respective communication message for another respective on-demand agent (e.g., a second on-demand agent 352-2) that processes another respective task subsequent to the respective task.
(A7-b) In some embodiments of A1-b to A6-b, the respective data includes a respective communication message for another respective on-demand artificial intelligence agent (e.g., a second on-demand agent 352-2) that processes another respective task subsequent to the respective task.
(A8-a) In some embodiments of A1-a to A7-a, receiving the user supervision 334 associated with the output data 332 includes: displaying the output data 332 to the user 306 by the first agent 350-1; and receiving a user input 336 including the user supervision 334 that identifies a correctness of the output data 332.
(A8-b) In some embodiments of A1-b to A7-b, receiving the user supervision 334 includes receiving a user input 336 including the user supervision 334 that identifies a correctness of the output data 332.
(A9-a) In some embodiments of A1-a to A8-a, determining whether the output data 332 requires updating includes: identifying, by the second agent 350-2, a respective on-demand agent associated with the user supervision 334; and determining, based on the user supervision 334 and by the respective on-demand agent of the one or more on-demand agents 352, whether the output data 332 requires updating.
(A9-b) In some embodiments of A1-b to A8-b, determining whether the output data 332 requires updating includes: identifying, by the internal orchestrating artificial intelligence agent (e.g., second agent 350-2), a respective on-demand artificial intelligence agent associated with the user supervision 334; and determining, based on the user supervision 334 and by the respective on-demand artificial intelligence agent of the one or more on-demand artificial intelligence agents (e.g., one or more on-demand agents 352), whether the output data 332 requires updating.
(A10-a) In some embodiments of A1-a to A9-a, determining whether the output data 332 requires updating includes in response to receiving the user supervision 334, determining, based on the user supervision 334 and by the second agent 350-2, whether the output data 332 requires updating.
(A10-b) In some embodiments of A1-b to A9-b, determining whether the output data 332 requires updating includes in response to receiving the user supervision 334, determining, based on the user supervision 334 and by the internal orchestrating artificial intelligence agent (e.g., second agent 350-2), whether the output data 332 requires updating.
(A11-a) In some embodiments of A1-a to A10-a, updating the output data 332 includes updating, based on the user supervision 334, a respective on-demand agent of the one or more on-demand agents 352.
(A11-b) In some embodiments of A1-b to A10-b, updating the output data 332 includes updating, based on the user supervision 334, a respective on-demand artificial intelligence agent of the one or more on-demand artificial intelligence agents (e.g., one or more on-demand agents 352).
(A12-a) In some embodiments of A1-a to A11-a, the method 900 further includes: iteratively receiving respective user supervision associated with respective output data by the first agent 350-1; determining, based on the respective user supervision and by the second agent 350-2, whether the respective output data requires updating; and in accordance with a determination that the respective output data requires updating, updating the respective output data.
(A12-b) In some embodiments of A1-b to A11-b, the method 900 further includes: iteratively receiving respective user supervision corresponding to the critical computing event and respective output data by the external interface artificial intelligence agent (e.g., first agent 350); determining, based on the respective user supervision and by the internal orchestrating artificial intelligence agent (e.g., second agent 350-2), whether the respective output data requires updating; and in accordance with a determination that the respective output data requires updating, updating, by the one or more on-demand artificial intelligence agents, the respective output data to generate respective updated output data for the internal orchestrating artificial intelligence agent.
(A13-a) In some embodiments of A1-a to A12-a, the plurality of computational components include at least one of the group consisting of (i) an analytical model, (ii) a large-language model, and (iii) a plugin.
(A13-b) In some embodiments of A1-b to A12-b, each artificial intelligence agent of the external interface artificial intelligence agent (e.g., first agent 350-1), the internal orchestrating artificial intelligence agent (e.g., second agent 350-2), and the one or more on-demand artificial intelligence agents (e.g., one or more on-demand agents 352) further includes an analytical model or a plugin.
(A14-a) In some embodiments of A1-a to A13-a, the user request 330 defines a request to reduce a respective mean time to repair (MTTR) for an incident stored in a first database. The output data include a respective standard operating procedure (SOP) configured to reduce the respective MTTR for the incident. The workflow 140 includes a respective step having a respective task for searching the incident in the first database.
(A14-b) In some embodiments of A1-b to A13-b, the request (e.g., user request 330) from the user defines a request to reduce a respective mean time to repair (MTTR) for a computing incident stored in a first database. The output data include a respective standard operating procedure (SOP) configured to reduce the respective MTTR for the computing incident. The workflow 140 includes a respective step having a respective task for searching the computing incident in the first database.
(A15-a) In some embodiments of A1-a to A14-a, the user request 330 defines a request to reduce a respective MTTR for a plurality of SOPs stored in a second database, the output data include a script with a set of code statements configured to reduce the respective MTTR for the plurality of SOPs. The workflow 140 includes a respective step having a respective task for receiving the plurality of SOPs from the second database.
(A15-b) In some embodiments of A1-b to A14-b, the request (e.g., user request 330) from the user defines a request to reduce a respective MTTR for a plurality of SOPs stored in a second database. The output data include a script with a set of code statements configured to reduce the respective MTTR for the plurality of SOPs. The workflow 140 includes a respective step having a respective task for receiving the plurality of SOPs from the second database.
(A16-a) In some embodiments of A1-a to A15-a, the second agent 350-2 is in compliance with a remote procedure call (RPC) framework for external functions.
(A16-b) In some embodiments of A1-b to A15-b, the internal orchestrating artificial intelligence agent (e.g., second agent 350-2) is in compliance with a remote procedure call (RPC) framework for external functions.
(A17-a) In some embodiments of A1-a to A16-a, the workflow 140 includes a schema in form of a JavaScript Object Notation (JSON).
(A17-b) In some embodiments of A1-b to A16-b, the workflow 140 includes a schema in form of a JavaScript Object Notation (JSON).
(A18-a) In some embodiments of A1-a to A17-a, generating the workflow 140 includes: parsing the user request 330 to generate an abstract syntax tree (AST); analyzing the AST to identify the plurality of steps 342; and generate the schema based on the plurality of steps 342.
(A18-b) In some embodiments of A1-b to A17-b, instantiating (e.g., generating) the workflow includes: parsing the request (e.g., user request 330) from the user to generate an abstract syntax tree (AST); analyzing the AST to identify the plurality of steps 342; and generate a schema based on the plurality of steps 342.
(B1-a) In accordance with some embodiments, a computer system includes one or more processors memory storing one or more programs. The one or more programs are configured to be executed by the one or more processors. The one or more programs include instructions for performing the method of any of A1-a to A18-a.
(B1-b) In accordance with some embodiments, a computer system includes one or more processors memory storing one or more programs. The one or more programs are configured to be executed by the one or more processors. The one or more programs include instructions for performing the method of any of A1-b to A18-b.
(C1-a) A non-transitory computer readable storage medium storing one or more programs. The one or more programs include instructions that, when executed by a computer system that includes one or more processors, cause the one or more processors to perform the method of any of A1-a to A18-a.
(C1-b) A non-transitory computer readable storage medium storing one or more programs. The one or more programs include instructions that, when executed by a computer system that includes one or more processors, cause the one or more processors to perform the method of any of A1-b to A18-b.

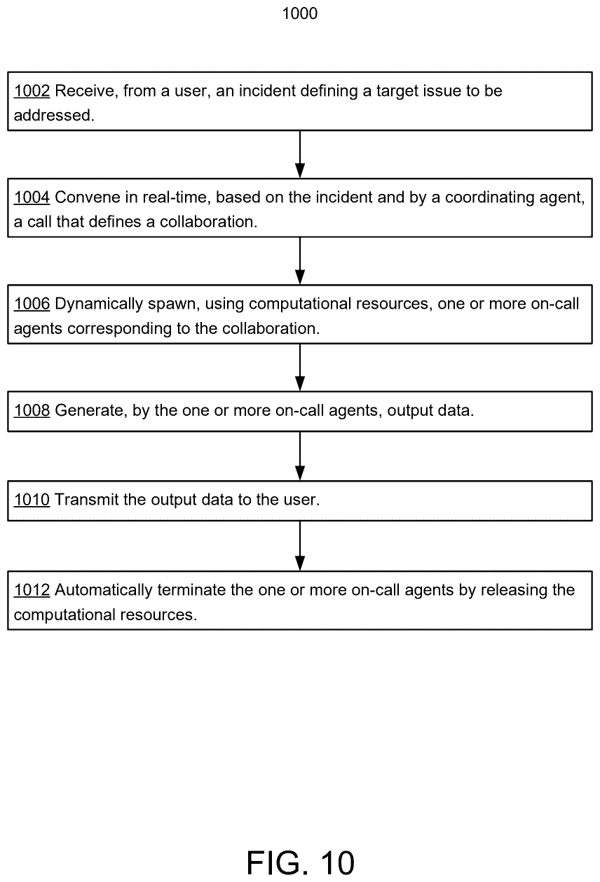

FIG. 10 is a flow diagram illustrating a method 1000 of orchestrating agents for resolving incidents, in accordance with some embodiments. The method 1000 may be performed at a computer system (e.g., the computer system 200, FIG. 2) having one or more processors and memory storing instructions for execution by the one or more processors. In some embodiments, the method 1000 is performed by executing instructions stored in memory (e.g., memory 210, FIG. 2) of the computer system.

In some embodiments, each of the agents described below is an artificial intelligence agent. In some embodiments, each of the agents described below includes an LLM. In some embodiments, each of the events described below is a critical event (e.g., associated with critical and high-priority incidents) and requires computation (e.g., real-time user/incident data analysis, code script generations, resource-intensive computations/inquiries, etc.). In some embodiments, the usage status described below includes the current state of resource utilization within the system (e.g., agentic system 102), providing insights into a dynamic consumption of computational and storage resources (e.g., percentage of resource occupation, such as CPU utilization, memory usage, storage consumption, network bandwidth usage, etc.). In particular, the usage status provides metrics that help assess the system's real-time performance, detect potential resource bottlenecks, and optimize resource allocation for efficient operation.
(D1-a) The method 1000 includes receiving (operation 1002), from a user 606, an incident 630 defining a target issue 631 to be addressed. The method 1000 further includes convening (operation 1004) in real-time, based on the incident 630 and by a coordinating agent 650, a call 660 that defines a collaboration 662. The method 1000 further includes dynamically spawning (operation 1006), using computational resources 604 (e.g., resource of functional platforms 104 in FIG. 1), one or more on-call agents 652 corresponding to the collaboration 662. The method 1000 further includes generating (operation 1008), by the one or more on-call agents 652, output data 632. The method 1000 further includes transmitting (operation 1010) the output data 632 to the user 606. The method 1000 further includes automatically terminating (operation 1012) the one or more on-call agents 652 by releasing the computational resources 604.
(D1-b) In some embodiments, the method 1000 includes receiving, from a user, a critical computing incident (e.g., incident 630) defining a target issue 631 to be addressed. The method 1000 further includes instantiating (e.g., generating) in real-time, based on the critical computing incident (e.g., incident 630) and by an interface coordinating artificial intelligence agent (e.g., coordinating agent 650), a call 660 that defines a collaboration 662. The method 1000 further includes dynamically allocating a set of computational resources (e.g., computational resources 604) from a pool of computational resources (e.g., resource of functional platforms 104 in FIG. 1) to the collaboration 662. The method 1000 further includes dynamically spawning, using the set of computational resources (e.g., computational resources 604), one or more on-call artificial intelligence agents (e.g., one or more on-call agents 652) corresponding to the collaboration 662. The method 1000 further includes generating, by the one or more on-call artificial intelligence agents (e.g., one or more on-call agents 652), output data 632. The method 1000 further includes transmitting the output data 632 to the user 606. The method 1000 further includes automatically monitoring a usage status (e.g., percentage of resource occupation, such as CPU utilization, memory usage, storage consumption, network bandwidth usage, etc.) of the pool of computational resources (e.g., resource of functional platforms 104 in FIG. 1). The method 1000 further includes automatically terminating, based on the usage status, the one or more on-call artificial intelligence agents (e.g., one or more on-call agents 652) by releasing the set of computational resources (e.g., computational resources 604). Each artificial intelligence agent of the interface coordinating artificial intelligence agent (e.g., coordinating agent 650) and the one or more on-call artificial intelligence agents (e.g., one or more on-call agents 652) is distinct from every other artificial intelligence agent and includes a large-language model.
(D2-a) In some embodiments of D1-a, the method 1000 further includes in response to receiving the incident 630, dynamically spawning the coordinating agent 650.
(D2-b) In some embodiments of D1-b, the method 1000 further includes in response to receiving the critical computing incident (e.g., incident 630), dynamically spawning the interface coordinating artificial intelligence agent (e.g., coordinating agent 650).
(D3-a) In some embodiments of D1-a to D2-a, the collaboration 662 includes a workflow 640 having a plurality of steps 642. The one or more on-call agents 652 includes a plurality of on-call agents (e.g., on-call agent 652-1 to on-call agent 652-n, where n is an integer greater than two). Each (e.g., first on-call agent 652-1) of the plurality of on-call agents is spawned for a respective step (e.g., first step 642-1) of the plurality of steps 642.
(D3-b) In some embodiments of D1-b to D2-b, the collaboration 662 includes a workflow 640 having a plurality of steps 642. The one or more on-call artificial intelligence agents (e.g., on-call agents 652) includes a plurality of on-call artificial intelligence agents (e.g., on-call agent 652-1 to on-call agent 652-n, where n is an integer greater than two). Each (e.g., first on-call agent 652-1) of the plurality of on-call artificial intelligence agents is spawned for a respective step (e.g., first step 642-1) of the plurality of steps 642.
(D4-a) In some embodiments of D1-b to D3-b, the method 1000 further includes, for each of the plurality of steps 642: dynamically spawning, using respective computational resources (e.g., from computational resources 604) and by a respective on-call agent, another respective on-call agent spawned for another respective step subsequent to a respective step.
(D4-b) In some embodiments of D1-b to D3-b, the method 1000 further includes, for each of the plurality of steps 642: dynamically spawning, using respective computational resources (e.g., from computational resources 604) of the set of computational resources and by a respective on-call artificial intelligence agent, another respective on-call artificial intelligence agent spawned for another respective step subsequent to a respective step.
(D5-a) In some embodiments of D1-a to D4-a, the method 1000 further includes, for each of the plurality of steps 642: generating, by the respective on-call agent, respective data; the other on-call agent spawned for the other respective step is dynamically spawned based in part on the respective data.
(D5-b) In some embodiments of D1-b to D4-b, the method 1000 further includes, for each of the plurality of steps 642: generating, by the respective on-call artificial intelligence agent, respective data; the other on-call artificial intelligence agent spawned for the other respective step is dynamically spawned based in part on the respective data
(D6-a) In some embodiments of D1-a to D5-a, when a respective step is an initial step (e.g., first step 642-1) of the plurality of steps 642, a respective on-call agent spawned for the respective step is dynamically spawned by the coordinating agent 650.
(D6-b) In some embodiments of D1-b to D5-b, when a respective step is an initial step (e.g., first step 642-1) of the plurality of steps 642, a respective on-call artificial intelligence agent spawned for the respective step is dynamically spawned by the interface coordinating artificial intelligence agent (e.g., coordinating agent 650).
(D7-a) In some embodiments of D1-a to D6-a, the method 1000 includes, for each of the plurality of steps 642: in accordance with a determination that a respective step requires an execution of a code script, temporarily suspending the respective step; sending, by a respective on-call agent, an authorization request 670 to the user 606; and in accordance with a determination that a user authorization 672 is received, resuming, by the respective on-call agent, the respective step.
(D7-b) In some embodiments of D1-b to D6-b, the method 1000 includes, for each of the plurality of steps 642: in accordance with a determination that a respective step requires an execution of a code script, temporarily suspending the respective step; sending, by a respective on-call artificial intelligence agent, an authorization request 670 to the user 606; and in accordance with a determination that a user authorization 672 is received, resuming, by the respective on-call artificial intelligence agent, the respective step.
(D8-a) In some embodiments of D1-a to D7-a, automatically terminating the one or more on-call agents 652 is performed in response to sending the output data 632 to the user 606.
(D8-b) In some embodiments of D1-b to D7-b, automatically terminating the one or more on-call artificial intelligence agents (e.g., on-call agents 652) is performed in response to sending the output data to the user
(D9-a) In some embodiments of D1-a to D8-a, automatically terminating the one or more on-call agents 652 is performed after a predetermined period elapses subsequent to transmitting the output data 632 to the user 606.
(D9-b) In some embodiments of D1-b to D8-b, automatically terminating the one or more on-call artificial intelligence agents (e.g., on-call agents 652) is performed after a predetermined period elapses subsequent to transmitting the output data to the user.
(D10-a) In some embodiments of D1-a to D9-a, automatically terminating the one or more on-call agents 652 is performed within a predetermined period and automatically ceases after the predetermined period elapses.
(D10-b) In some embodiments of D1-b to D9-b, automatically terminating the one or more on-call artificial intelligence agents (e.g., on-call agents 652) is performed within a predetermined period and automatically ceases after the predetermined period elapses
(D11-a) In some embodiments of D1-a to D10-a, the incident 630 includes a severity level (e.g., high-severity “S1,” medium-severity “S2,” low-severity “S3,” etc.) and/or a priority level (e.g., critical-priority “P1,” high-priority “P2,” medium-priority “P3,” low-priority “P4,” etc.). The call 660 is convened based in part on the severity level and/or the priority level.
(D11-b) In some embodiments of D1-b to D10-b, the critical computing incident (e.g., incident 630) includes a severity level (e.g., high-severity “S1,” medium-severity “S2,” low-severity “S3,” etc.) and/or a priority level (e.g., critical-priority “P1,” high-priority “P2,” medium-priority “P3,” low-priority “P4,” etc.). The call 660 is convened based in part on the severity level and/or the priority level.
(D12-a) In some embodiments of D1-a to D11-a, the computational resources includes at least one of the group consisting of (i) computing resources, (ii) memory resources, and (iii) cloud resources.
(D12-b) In some embodiments of D1-b to D11-b, the set of computational resources includes at least one of the group consisting of (i) computing resources, (ii) memory resources, and (iii) cloud resources
(D13-a) In some embodiments of D1-a to D12-a, the method 1000 includes receiving user supervision 634 associated with the output data 632. The method 1000 further includes determining, based on the user supervision 634 and by a respective agent of the coordinating agent 650 and the one or more on-call agents 652, whether the output data 632 requires updating. The method 1000 further includes in accordance with a determination that the output data 632 requires updating, updating the output data. The method 1000 further includes transmitting the updated output data 632′ to the user 606.
(D13-b) In some embodiments of D1-b to D12-b, the method 1000 includes receiving user supervision 634 associated with the output data 632. The method 1000 further includes determining, based on the user supervision 634 and by a respective artificial intelligence agent of the interface coordinating artificial intelligence agent (e.g., coordinating agent 650) and the one or more on-call artificial intelligence agents (e.g., one or more on-call agents 652), whether the output data 632 requires updating. The method 1000 further includes in accordance with a determination that the output data 632 requires updating, updating the output data. The method 1000 further includes transmitting the updated output data 632′ to the user 606.
(D14-a) In some embodiments of D1-a to D13-a, each agent of the coordinating agent 650 and the one or more on-call agents 652 is driven by a respective computational component.
(D14-b) In some embodiments of D1-b to D13-b, each artificial intelligence agent of the interface coordinating artificial intelligence agent (e.g., coordinating agent 650) and the one or more on-call artificial intelligence agents (e.g., one or more on-call agents 652) is driven by a respective computational component.
(D15-a) In some embodiments of D1-a to D14-a, the respective computational component includes at least one of the group consisting of (i) an analytical model, (ii) a large-language model, and (iii) a plugin.
(D15-b) In some embodiments of D1-b to D14-b, each artificial intelligence agent of the interface coordinating artificial intelligence agent (e.g., coordinating agent 650) and the one or more on-call artificial intelligence agents (e.g., one or more on-call agents 652) includes an analytical model or a plugin.
(D16-a) In some embodiments of D1-a to D15-a, the receiving the incident 630 and the transmitting the output data 632 are performed in a graphical portal (e.g., example UI 400 in FIG. 4).
(D16-b) In some embodiments of D1-b to D15-b, the receiving the critical computing incident (e.g., incident 630) and the transmitting the output data 632 are performed in a graphical portal (e.g., example UI 400 in FIG. 4).
(E1-a) In accordance with some embodiments, a computer system includes one or more processors memory storing one or more programs. The one or more programs are configured to be executed by the one or more processors. The one or more programs include instructions for performing the method of any of D1-a to D16-a.
(E1-b) In accordance with some embodiments, a computer system includes one or more processors memory storing one or more programs. The one or more programs are configured to be executed by the one or more processors. The one or more programs include instructions for performing the method of any of D1-b to D16-b.
(F1-a) A non-transitory computer readable storage medium storing one or more programs. The one or more programs include instructions that, when executed by a computer system that includes one or more processors, cause the one or more processors to perform the method of any of D1-a to D16-a.
(F1-b) A non-transitory computer readable storage medium storing one or more programs. The one or more programs include instructions that, when executed by a computer system that includes one or more processors, cause the one or more processors to perform the method of any of D1-b to D16-b.

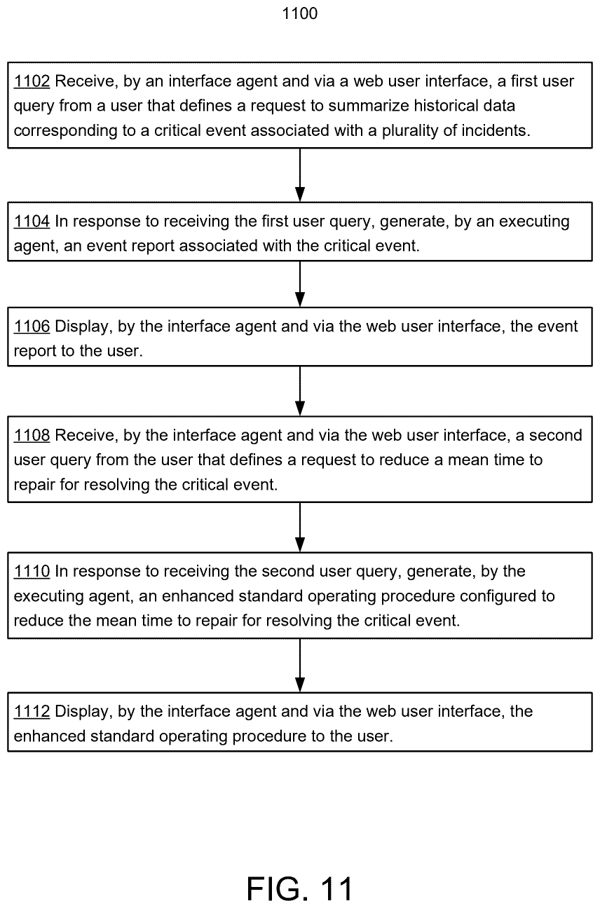

FIG. 11 is a flow diagram illustrating a method 1100 of orchestrating agents for self-service, in accordance with some embodiments. The method 1100 may be performed at a computer system (e.g., the computer system 200, FIG. 2) having one or more processors and memory storing instructions for execution by the one or more processors. In some embodiments, the method 1100 is performed by executing instructions stored in memory (e.g., memory 210, FIG. 2) of the computer system.

In some embodiments, each of the agents described below is an artificial intelligence agent. In some embodiments, each of the agents described below includes an LLM. In some embodiments, each of the events described below is a critical event (e.g., associated with critical and high-priority incidents) and requires computation (e.g., real-time user/incident data analysis, code script generations, resource-intensive computations/inquiries, etc.).
(G1-a) The method 1100 includes receiving (operation 1102), by an interface agent 750-1 and via a web user interface 702, a first user query 730-1 from a user 706 that defines a request to summarize historical data 712 corresponding to a critical event 710 associated with a plurality of incidents 714. The method 1100 further includes in response to receiving the first user query 730-1, generating (operation 1104), by an executing agent 750-2, an event report 732 associated with the critical event 710. The method 1100 further includes displaying (operation 1106), by the interface agent 750-1 and via the web user interface 702, the event report 732 to the user 706. The method 1100 further includes receiving (operation 1108), by the interface agent 750-1 and via the web user interface 702, a second user query 730-2 from the user 706 that defines a request to reduce a mean time to repair (MTTR) for resolving the critical event 710. The method 1100 further includes in response to receiving the second user query 730-2, generating (operation 1110), by the executing agent 750-2, an enhanced standard operating procedure (SOP) 738 configured to reduce the MTTR for resolving the critical event 710. The method 1100 further includes displaying (operation 1112), by the interface agent 750-1 and via the web user interface 702, the enhanced SOP 738 to the user 706.
(G1-b) In some embodiments, the method 1100 includes receiving, by an interface artificial intelligence agent (e.g., interface agent 750-1) and via a web user interface 702, a first user query 730-1 from a user 706 that defines a request to summarize historical data 712 corresponding to a critical computing event (e.g., critical event 710) associated with a plurality of computing incidents (e.g., plurality of incidents 714). The method 1100 further includes in response to receiving the first user query 730-1, generating, by an executing artificial intelligence agent (e.g., executing agent 750-2), an event report 732 associated with the critical computing event (e.g., critical event 710). The method 1100 further includes displaying, by the interface artificial intelligence agent (e.g., interface agent 750-1) and via the web user interface 702, the event report 732 to the user 706. The method 1100 further includes receiving, by the interface artificial intelligence agent (e.g., interface agent 750-1) and via the web user interface 702, a second user query 730-2 from the user 706 that defines a request to reduce a mean time to repair (MTTR) for resolving the critical computing event (e.g., critical event 710). The method 1100 further includes in response to receiving the second user query 730-2, generating, by the executing artificial intelligence agent (e.g., executing agent 750-2), an enhanced standard operating procedure (SOP) 738 configured to reduce the MTTR for resolving the critical computing event (e.g., critical event 710). The method 1100 further includes displaying, by the interface artificial intelligence agent (e.g., interface agent 750-1) and via the web user interface 702, the enhanced SOP 738 to the user 706. Each artificial intelligence agent of the interface artificial intelligence agent (e.g., interface agent 750-1) and the executing artificial intelligence agent (e.g., executing agent 750-2) is distinct from the other and includes a large-language model.
(G2-a) In some embodiments of G1-a, the historical data 712 includes a plurality of SOPs 716 (e.g., SOP 716-1 to SOP 716-k, where k is an integer greater than two). Each (e.g., SOP 716-1) of plurality of SOPs 716 is associated with a corresponding incident (e.g., incident 714-1) of the plurality of incidents 714.
(G2-b) In some embodiments of G1-b, the historical data 712 includes a plurality of SOPs 716 (e.g., SOP 716-1 to SOP 716-k, where k is an integer greater than two). Each (e.g., SOP 716-1) of plurality of SOPs 716 is associated with a corresponding computing incident (e.g., incident 714-1) of the plurality of computing incidents (e.g., plurality of incidents 714).
(G3-a) In some embodiments of G1-a to G2-a, the historical data 712 includes a plurality of incident logs 718 (e.g., incident log 718-1 to incident log 718-k, where k is an integer greater than two). Each (e.g., incident log 718-1) of the plurality of incident logs 718 is associated with a corresponding incident (e.g., incident 714-1) of the plurality of incidents 714 and has a corresponding resolution history.
(G3-b) In some embodiments of G1-b to G2-b, the historical data 712 includes a plurality of computing incident logs (e.g., incident log 718-1 to incident log 718-k, where k is an integer greater than two). Each (e.g., incident log 718-1) of the plurality of computing incident logs (e.g., incident logs 718) is associated with a corresponding computing incident (e.g., incident 714-1) of the plurality of computing incidents (e.g., incidents 714) and has a corresponding resolution history.
(G4-a) In some embodiments of G1-a to G3-a, in response to receiving the first user query 730-1, generating, by the executing agent 750-2, the event report 732 associated with the critical event 710 includes transmitting, by the interface agent 750-1, the first user query 730-1 to the executing agent 750-2; retrieving, by the executing agent 750-2 and based on the first user query 730-1, the historical data 712 from a repository database 704; generating, by the executing agent 750-2, the event report 732 to summarize the historical data 712; and sending, by the executing agent 750-2, the event report 732 to the interface agent 750-1.
(G4-b) In some embodiments of G1-b to G3-b, in response to receiving the first user query 730-1, generating, by the executing artificial intelligence agent (e.g., executing agent 750-2), the event report 732 associated with the critical computing event (e.g., critical event 710) includes transmitting, by the interface artificial intelligence agent (e.g., interface agent 750-1), the first user query 730-1 to the executing artificial intelligence agent (e.g., executing agent 750-2); retrieving, by the executing artificial intelligence agent (e.g., executing agent 750-2) and based on the first user query 730-1, the historical data 712 from a repository database 704; generating, by the executing artificial intelligence agent (e.g., executing agent 750-2), the event report 732 to summarize the historical data 712; and transmitting, by the executing artificial intelligence agent (e.g., executing agent 750-2), the event report 732 to the interface artificial intelligence agent (e.g., interface agent 750-1).
(G5-a) In some embodiments of G1-a to G4-a, in response to receiving the second user query 730-2, generating, by the executing agent 750-2, the enhanced SOP 738 configured to reduce the MTTR for resolving the critical event 710 includes: transmitting, by the interface agent 750-1, the second user query 730-2 to the executing agent 750-2; analyzing, by the executing agent 750-2 and based on the second user query 730-2, the historical data 712 to generate the enhanced SOP 738 configured to reduce the MTTR for resolving the critical event 710; and sending, by the executing agent 750-2, the enhanced SOP 738 to the interface agent 750-1.
(G5-b) In some embodiments of G1-b to G4-b, in response to receiving the second user query 730-2, generating, by the executing artificial intelligence agent (e.g., executing agent 750-2), the enhanced SOP 738 configured to reduce the MTTR for resolving the critical computing event (e.g., critical event 710) includes: transmitting, by the interface artificial intelligence agent (e.g., interface agent 750-1), the second user query 730-2 to the executing artificial intelligence agent (e.g., executing agent 750-2); analyzing, by the executing artificial intelligence agent (e.g., executing agent 750-2) and based on the second user query 730-2, the historical data 712 to generate the enhanced SOP 738 configured to reduce the MTTR for resolving the critical computing event (e.g., critical event 710); and transmitting, by the executing artificial intelligence agent (e.g., executing agent 750-2), the enhanced SOP 738 to the interface artificial intelligence agent (e.g., interface agent 750-1).
(G6-a) In some embodiments of G1-a to G5-a, the enhanced SOP 738 includes a code script 740 configured to generate a textual SOP corresponding to the enhanced SOP 738. Analyzing the historical data 712 includes validating, by the executing agent 750-2, the code script 740 to minimize errors.
(G6-b) In some embodiments of G1-b to G5-b, the enhanced SOP 738 includes a code script 740 configured to generate a textual SOP corresponding to the enhanced SOP 738. Analyzing the historical data 712 includes validating, by the artificial intelligence executing agent (e.g., executing agent 750-2), the code script 740 to minimize errors.
(G7-a) In some embodiments of G1-a to G6-a, the executing agent 750-2 includes a coordinating agent (e.g., coordinating agent 650 in FIG. 6) and one or more on-call agents (e.g., one or more on-call agents 652 in FIG. 6) dynamically spawned by the coordinating agent (e.g., coordinating agent 650 in FIG. 6).
(G7-b) In some embodiments of G1-b to G6-b, the executing artificial intelligence agent (e.g., executing agent 750-2) includes an interface coordinating artificial intelligence agent (e.g., coordinating agent 650 in FIG. 6) and one or more on-call artificial intelligence agents (e.g., one or more on-call agents 652 in FIG. 6) dynamically spawned by the interface coordinating artificial intelligence agent (e.g., coordinating agent 650 in FIG. 6) using computational resources (e.g., resource of functional platforms 104 in FIG. 1).
(G8-a) In some embodiments of G1-a to G7-a, each agent of the interface agent 750-1 and the executing agent 750-2 is driven by a respective computational component.
(G8-b) In some embodiments of G1-b to G7-b, each artificial intelligence agent of the interface artificial intelligence agent (e.g., interface agent 750-1) and the executing artificial intelligence agent 750-2 (e.g., executing agent 750-2) is driven by a respective computational component.
(G9-a) In some embodiments of G1-a to G8-a, the respective computational component includes at least one of the group consisting of (i) an analytical model, (ii) a large-language model, and (iii) a plugin.
(G9-b) In some embodiments of G1-b to G8-b, each artificial intelligence agent of the interface artificial intelligence agent (e.g., interface agent 750-1) and the executing artificial intelligence agent (e.g., executing agent 750-2) includes an analytical model or a plugin.
(H1-a) In accordance with some embodiments, a computer system includes one or more processors memory storing one or more programs. The one or more programs are configured to be executed by the one or more processors. The one or more programs include instructions for performing the method of any of G1-a to G9-a.
(H1-b) In accordance with some embodiments, a computer system includes one or more processors memory storing one or more programs. The one or more programs are configured to be executed by the one or more processors. The one or more programs include instructions for performing the method of any of G1-b to G9-b.
(I1-a) A non-transitory computer readable storage medium storing one or more programs. The one or more programs include instructions that, when executed by a computer system that includes one or more processors, cause the one or more processors to perform the method of any of G1-a to G9-a.
(I1-b) A non-transitory computer readable storage medium storing one or more programs. The one or more programs include instructions that, when executed by a computer system that includes one or more processors, cause the one or more processors to perform the method of any of G1-b to G9-b.

Although FIGS. 9-11 illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method, performed by a computer system with one or more processors, of orchestrating artificial intelligence agents for self-service, comprising:
receiving, by an interface artificial intelligence agent and via a web user interface, a first user query from a user that defines a request to summarize historical data corresponding to a critical computing event associated with a plurality of computing incidents;
in response to receiving the first user query, generating, by an executing artificial intelligence agent, an event report associated with the critical computing event;
displaying, by the interface artificial intelligence agent and via the web user interface, the event report to the user;
receiving, by the interface artificial intelligence agent and via the web user interface, a second user query from the user that defines a request to reduce a mean time to repair (MTTR) for resolving the critical computing event;
in response to receiving the second user query, generating, by the executing artificial intelligence agent, an enhanced standard operating procedure (SOP) configured to reduce the MTTR for resolving the critical computing event; and
displaying, by the interface artificial intelligence agent and via the web user interface, the enhanced SOP to the user, wherein:
each artificial intelligence agent of the interface artificial intelligence agent and the executing artificial intelligence agent is distinct from the other and includes a large-language model.

2. The method of claim 1, wherein:
the historical data includes a plurality of SOPs and each of plurality of SOPs is associated with a corresponding computing incident of the plurality of computing incidents.

3. The method of claim 1, wherein:
the historical data includes a plurality of computing incident logs; and
each of the plurality of computing incident logs is associated with a corresponding computing incident of the plurality of computing incidents and has a corresponding resolution history.

4. The method of claim 1, wherein in response to receiving the first user query, generating, by the executing artificial intelligence agent, the event report associated with the critical computing event includes:
transmitting, by the interface artificial intelligence agent, the first user query to the executing artificial intelligence agent;
retrieving, by the executing artificial intelligence agent and based on the first user query, the historical data from a repository database;
generating, by the executing artificial intelligence agent, the event report to summarize the historical data; and
transmitting, by the executing artificial intelligence agent, the event report to the interface artificial intelligence agent.

5. The method of claim 1, wherein in response to receiving the second user query, generating, by the executing artificial intelligence agent, the enhanced SOP configured to reduce the MTTR for resolving the critical computing event includes:
transmitting, by the interface artificial intelligence agent, the second user query to the executing artificial intelligence agent;
analyzing, by the executing artificial intelligence agent and based on the second user query, the historical data to generate the enhanced SOP configured to reduce the MTTR for resolving the critical computing event; and
transmitting, by the executing artificial intelligence agent, the enhanced SOP to the interface artificial intelligence agent.

6. The method of claim 5, wherein the enhanced SOP includes a code script configured to generate a textual SOP corresponding to the enhanced SOP, and analyzing the historical data includes:
validating, by the executing artificial intelligence agent, the code script to minimize errors.

7. The method of claim 5, wherein the executing artificial intelligence agent includes an interface coordinating artificial intelligence agent and one or more on-call artificial intelligence agents dynamically spawned by the interface coordinating artificial intelligence agent using computational resources.

8. The method of claim 1, wherein each artificial intelligence agent of the interface artificial intelligence agent and the executing artificial intelligence agent is driven by a respective computational component.

9. The method of claim 1, wherein each artificial intelligence agent of the interface artificial intelligence agent and the executing artificial intelligence agent includes an analytical model or a plugin.

10. A computer system, comprising:
one or more processors; and
memory storing one or more programs, wherein the one or more programs are configured to be executed by the one or more processors, the one or more programs including instructions for:
receiving, by an interface artificial intelligence agent and via a web user interface, a first user query from a user that defines a request to summarize historical data corresponding to a critical computing event associated with a plurality of computing incidents;
in response to receiving the first user query, generating, by an executing artificial intelligence agent, an event report associated with the critical computing event;
displaying, by the interface artificial intelligence agent and via the web user interface, the event report to the user;
receiving, by the interface artificial intelligence agent and via the web user interface, a second user query from the user that defines a request to reduce a mean time to repair (MTTR) for resolving the critical computing event;
in response to receiving the second user query, generating, by the executing artificial intelligence agent, an enhanced standard operating procedure (SOP) configured to reduce the MTTR for resolving the critical computing event; and
displaying, by the interface artificial intelligence agent and via the web user interface, the enhanced SOP to the user, wherein:
each artificial intelligence agent of the interface artificial intelligence agent and the executing artificial intelligence agent is distinct from the other and includes a large-language model.

11. A non-transitory computer readable storage medium storing one or more programs, the one or more programs comprising instructions that, when executed by a computer system that includes one or more processors, cause the one or more processors to perform operations comprising:
receiving, by an interface artificial intelligence agent and via a web user interface, a first user query from a user that defines a request to summarize historical data corresponding to a critical computing event associated with a plurality of computing incidents;
in response to receiving the first user query, generating, by an executing artificial intelligence agent, an event report associated with the critical computing event;
displaying, by the interface artificial intelligence agent and via the web user interface, the event report to the user;
receiving, by the interface artificial intelligence agent and via the web user interface, a second user query from the user that defines a request to reduce a mean time to repair (MTTR) for resolving the critical computing event;
in response to receiving the second user query, generating, by the executing artificial intelligence agent, an enhanced standard operating procedure (SOP) configured to reduce the MTTR for resolving the critical computing event; and
displaying, by the interface artificial intelligence agent and via the web user interface, the enhanced SOP to the user, wherein:
each artificial intelligence agent of the interface artificial intelligence agent and the executing artificial intelligence agent is distinct from the other and includes a large-language model.
